(19) United States
(12) Patent Application Publication
(10) Pub. No.: US 2002/0019675 A1
(43) Pub. Date: Feb. 14, 2002

(54) 3-dimensional model-processing apparatus, 3-dimensional model-processing method and program-providing medium

(76) Inventors: Norikazu Hiraki, Tokyo (JP); Hiroyuki Segawa, Kanagawa (JP); Hiroyuki Shioya, Tokyo (JP); Yuichi Abe, Tokyo (JP)

Correspondence Address: Bell, Boyd & Lloyd LLC, P.O. Box 1135, Chicago, IL, 60690, US

(21) Appl. No.: 09/855,373

(22) Filed: May 15, 2001

(30) Foreign Application Priority Data
May 15, 2000 (JP) P2000-141934

(51) Int. Cl. G05B 19/18

(52) U.S. Cl. 700/65

(57) ABSTRACT

Disclosed is a 3-dimensional-model-processing apparatus for carrying out various kinds of processing, such as processing to deform a 3-dimensional model appearing on a display unit and processing to paint the model on the basis of 3-dimensional-position information input from a 3-dimensional sensor, the 3-dimensional-model-processing apparatus comprising control means for setting an operating point or an operating area used as a position at which processing using a processing tool is to be carried out on the 3-dimensional model serving as a processed object appearing on the display unit as a position dependent upon the position of the processing tool and carrying out the processing on the 3-dimensional model at the set operating point or the set operating area.

### BACKGROUND OF THE INVENTION

In general, the present invention relates to a 3-dimensional-model-processing apparatus, a 3-dimensional-model-processing method, and a program presenting medium which are used for carrying out processing such as deformation and painting on a 3-dimensional model appearing on a display unit of typically a personal computer. More particularly, the present invention relates to a 3-dimensional-model-processing apparatus, a 3-dimensional-model-processing method, and a program presenting medium which allow the operator to operate a virtual-object tool as well as a variety of editing tools, such as a shape-changing tool and a paint tool on a 3-dimensional model appearing on a display unit in order to redisplay the 3-dimensional model on the display unit with a variety of modified attributes of the 3-dimensional model, such as a modified shape and a modified color obtained as a result of operations carried out by the operator.

In order to deform a 3-dimensional model defined in a 3-dimensional space with contemporary computer graphic software and modeling software represented by a 3-dimensional CAD program, there is mainly adopted a method of using a 2-dimensional input device represented by a keyboard and a mouse in many cases. In this case, however, a 3-dimensional model is operated by using a 2-dimensional device. Thus, the operation is carried out not intuitively and the operation is cumbersome in many cases.

Meanwhile, a system for deforming a 3-dimensional model by using a glove-type input unit has been implemented as part of research in virtual reality An operation to enter an input via a glove-type input unit is considered to be intuitive. In actuality, however, it is necessary to determine some gestures in order to select which concrete operations, such as push or pull operations, are to be carried out. Thus, the intuitive operation may not necessarily correspond to processing. In addition, the size of a hand varies from person to person. For a person with a hand not matching the size of the glove, it becomes extremely difficult to carry out an operation.

As described above, a variety of methods are adopted in the conventional 3-dimensional information input system. In a processing system using a 2-dimensional tablet and the mouse described above, however, processing is carried out to input 2-dimensional information. Thus, a constraint on an operation of a 3-dimensional object and a sense of incompatibility exist. In addition, it is necessary to carry out various kinds of processing such as movement, deformation and truncation on a displayed object by using only one tool such as a mouse. Thus, there are problems and difficulties for the operator to intuitively, use the tool setting.

Moreover, while the operator is capable of carrying out processing to enter an input by using a glove-type manipulator by means of a sense close to reality, in actuality, some initial setting is necessary before processing. An example of the initial setting is the aforementioned concrete processing, such an operation to push or to pull an object. Thus, for a user unfamiliar with manipulator operations, there is a shortcoming that the operations are difficult to carry out.

### SUMMARY OF THE INVENTION

An advantage of the present invention, addressing the problems described above, is to provide a 3-dimensional-model-processing apparatus and a 3-dimensional-model-processing method which are used for carrying out various kinds of processing such as modification of the shape of a displayed 3-dimensional model and coloring of a surface of the model, and allow the operator to grasp a processing point with ease by aiding the operator's perception of depth and distance in a 2-dimensional display unit by providing a configuration including a 3-dimensional sensor for modifying the position as well as the posture of the 3-dimensional model, and a 3-dimensional sensor for operating a deformation tool for deforming the 3-dimensional model, wherein, by utilizing the perception of a relative relation between the 3-dimensional model and the deformation tool (such as the right and left hands), it is possible to carry out processing of the 3-dimensional model by means of an actual sense, and an operating point of processing can be set in the tool.

According to an embodiment of the present invention, a 3-dimensional-model-processing apparatus is provided for carrying out various kinds of processing, such as processing to deform a 3-dimensional model appearing on a display unit and processing to paint the model on the basis of 3-dimensional-position information input from a 3-dimensional sensor, the 3-dimensional-model-processing apparatus including control means for setting an operating point or an operating area used as a position at which processing using a processing tool is to be carried out on the 3-dimensional model serving as a processed object appearing on the display unit as a position dependent upon the position of the processing tool and carrying out the processing on the 3-dimensional model at the set operating point or the set operating area.

Preferably, the control means sets an overlap portion of the operating point or the operating area and the 3-dimensional model as a processing execution position.

The control means preferably executes control to clearly display the operating point or the operating area on the display unit.

Preferably, the operating point or the operating area is allowed to be updated as a position dependent upon the processing tool by changing and/or re-setting the operating point or the operating area, and the control means carries out, if the operating point or the operating area is updated, the processing on the 3-dimensional model at the updated operating point or the updated operating area.

Preferably, the control means executes control to make the operating point movable, constraining the operating point on positions on the surface of the 3-dimensional model being processed.

Preferably, the operating area is set as an area having a shape matching the shape of the processing tool, and the control means carries out processing according to the shape of the operating area set as an area having a shape matching the shape of the processing tool on the 3-dimensional model.

Preferably, the control means carries out processing on the 3-dimensional model on the condition that an overlap portion of the operating point or the operating area and the 3-dimensional model has been detected.

Preferably, the control means carries out processing on the 3-dimensional model on the condition that an overlap portion of the operating point or the operating area and the 3-dimensional model has been detected and that a processing command has been received from input means.

According to another embodiment of the present invention, a 3-dimensional-model-processing method is provided for carrying out various kinds of processing, such as processing to deform a 3-dimensional model appearing on a display unit and processing to paint the model on the basis of 3-dimensional-position information input from a 3-dimensional sensor, including the steps of setting an operating point or an operating area used as a position at which processing using a processing tool is to be carried out on the 3-dimensional model serving as a processed object appearing on a display unit as a position dependent upon the position of the processing tool, and carrying out the processing on the 3-dimensional model at the set operating point or the set operating area.

The above-described 3-dimensional-model-processing method may further include the step of setting an overlap portion of the operating point or the operating area and the 3-dimensional model as a processing execution position.

The 3-dimensional-model-processing method may further include the step of clearly displaying the operating point or the operating area on the display unit.

Preferably, the operating point or the operating area is allowed to be updated as a position dependent upon the processing tool by changing and/or re-setting the operating point or the operating area, and if the operating point or the operating area is updated, the processing on the 3-dimensional model is carried out at the updated operating point or the updated operating area.

The 3-dimensional-model-processing method may further include the step of executing control to make the operating point movable, constraining the operating point on positions on the surface of the 3-dimensional model being processed.

The 3-dimensional-model-processing method may further include the steps of setting the operating area as an area having a shape matching the shape of the processing tool, and carrying out processing according to the operating area set as an area having a shape matching the shape of the processing tool on the 3-dimensional model.

The 3-dimensional-model-processing method may further include the step of carrying out processing on the 3-dimensional model on the condition that an overlap portion of the operating point or the operating area and the 3-dimensional model has been detected.

The 3-dimensional-model-processing method may further include the step of carrying out processing on the 3-dimensional model on the condition that an overlap portion of the operating point or the operating area and the 3-dimensional model has been detected and that a processing command has been received from input means.

According to another embodiment of the present invention, a program-providing medium for a computer program to be executed on a computer system is provided for carrying out various kinds of processing such as deformation and painting of a 3-dimensional model appearing on a display unit on the basis of 3-dimensional positional information input from a 3-dimensional sensor, including the steps of setting an operating point or an operating area used as a position at which processing using a processing tool is to be carried out on the 3-dimensional model serving as a processed object appearing on a display unit as a position dependent upon the position of the processing tool, and carrying out the processing on the 3-dimensional model at the set operating point or the set operating area.

The program-providing medium according to this embodiment is a medium for providing a computer program in a computer-readable format to a typical general-purpose computer capable of executing a variety of programs and codes. Examples of the program-providing medium are a storage medium such as a CD (compact disc), an FD (floppy disc) or an MO (magneto-optical) disc and a transmission medium such as a network. The format of the program-providing medium is not prescribed in particular.

Such a program-providing medium defines a structural and functional cooperative relation between the computer program and the providing medium to implement predetermined functions of the computer program on the general-purpose computer system. In other words, by installation of the computer program from the program-providing medium in the general-purpose computer system, effects of collaboration can be displayed on the computer system and the same effects as the other aspects of the present invention can thus be obtained.

Other objects, features and merits of the present invention will probably become apparent from the following Detailed Description of the Preferred Embodiments of the present invention with reference to accompanying diagrams.

### DESCRIPTION OF THE DRAWINGS

FIG. 1 is a block diagram showing the hardware configuration of a 3-dimensional-model-processing apparatus provided by the present invention;

FIG. 2 is a diagram showing a display by the 3-dimensional-model-processing apparatus provided by the present invention and a typical configuration of a sensor;

FIG. 3 is a flowchart representing a deformation subroutine of the 3-dimensional-model-processing apparatus provided by the present invention;

FIG. 4 is an explanatory diagram showing a tool and an operating point in the 3-dimensional-model-processing apparatus provided by the present invention;

FIGS. 5A and 5B are diagrams each showing typical deformation processing based on an operating point set in a tool in the 3-dimensional-model-processing apparatus provided by the present invention;

FIGS. 6A through 6C are explanatory diagrams showing an outline of processing to move a surface point set as an operating point in the 3-dimensional-model-processing apparatus provided by the present invention;

FIG. 7 is a flowchart representing a surface-point subroutine in the 3-dimensional-model-processing apparatus provided by the present invention;

FIG. 8 is a flowchart representing a surface-point-generating subroutine in the 3-dimensional-model-processing apparatus provided by the present invention;

FIGS. 9A through 9C are diagrams each showing a model applying a flowchart representing a surface-point-generating subroutine in the 3-dimensional-model-processing apparatus provided by the present invention;

FIG. 10 is a flowchart representing a surface-point-updating subroutine in the 3-dimensional-model-processing apparatus provided by the present invention;

FIGS. 11A and 11B are diagrams each showing a model applying a flowchart representing a surface-point-updating subroutine in the 3-dimensional-model-processing apparatus provided by the present invention;

FIG. 12 is a flowchart representing processing using a push-pull deformation tool in the 3-dimensional-model-processing apparatus provided by the present invention;

FIG. 13 is an explanatory diagram showing FFD processing applicable as an implementation of deformation processing in the 3-dimensional-model-processing apparatus provided by the present invention;

FIG. 14 is an explanatory diagram showing an operating point of a pinch tool in the 3-dimensional-model-processing apparatus provided by the present invention;

FIG. 15 is a flowchart representing processing using a press tool in the 3-dimensional-model-processing apparatus provided by the present invention;

FIG. 16 is an explanatory diagram showing an operating area of a spray tool in the 3-dimensional-model-processing apparatus provided by the present invention;

FIG. 17 is a flowchart representing processing using a spray tool in the 3-dimensional-model-processing apparatus provided by the present invention;

FIGS. 18A through 18D are explanatory diagrams showing an implementation of processing using a spray tool in the 3-dimensional-model-processing apparatus provided by the present invention;

FIG. 19 is an explanatory diagram showing an operating area of a tanning tool in the 3-dimensional-model-processing apparatus provided by the present invention;

FIGS. 20A through 20C are explanatory diagrams showing an implementation of processing using a tanning tool in the 3-dimensional-model-processing apparatus provided by the present invention;

FIG. 21 is an explanatory diagram showing processing using a tanning tool in the 3-dimensional-model-processing apparatus provided by the present invention;

FIG. 22 is an explanatory diagram showing an implementation of processing using a removal tool in the 3-dimensional-model-processing apparatus provided by the present invention;

FIG. 23 is an explanatory diagram showing another implementation of processing using the removal tool in the 3-dimensional-model-processing apparatus provided by the present invention; and

FIG. 24 is a flowchart representing processing using a removal tool in the 3-dimensional-model-processing apparatus provided by the present invention.

### DETAILED DESCRIPTION OF THE PREFERRED EMBODIMENTS

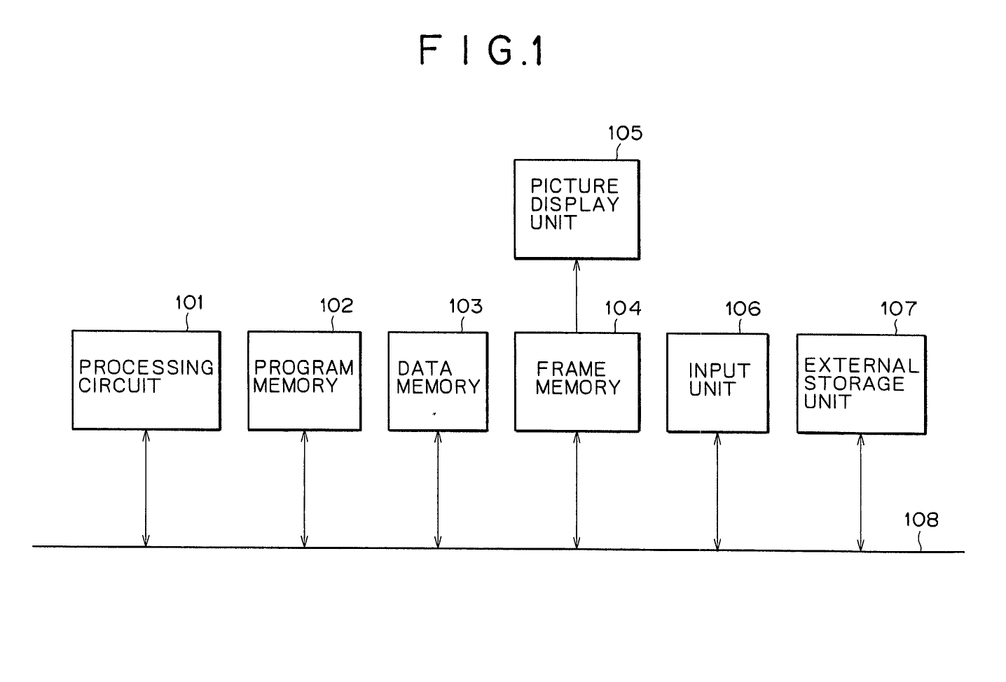

FIG. 1 shows a block diagram of a 3-dimensional-model-processing system to which the present invention's 3-dimensional-model-processing apparatus and 3-dimensional-model-processing method can be applied.

As shown in FIG. 1, the 3-dimensional-model-processing system comprises main components, such as a processing circuit 101, a program memory 102, a data memory 103, a frame memory 104, a picture display unit 105, an input unit 106, and an external storage unit 107. The processing circuit 101, the program memory 102, the data memory 103, the frame memory 104, the input unit 106 and the external storage unit 107 are connected to each other by a bus 108 in a configuration allowing data to be exchanged among them through the bus 108. The processing circuit 101 is a CPU (central processing unit) for executing a variety of processing programs to carry out, among other processes, processing to generate display data of a 3-dimensional model, processing to control an operation to display a processing tool and processing to change attributes of a 3-dimensional model, such as deformation or painting of the 3-dimensional model. The program memory 102 includes a RAM (random-access memory) and a ROM (read-only memory) which are used for storing the processing programs. The data memory 103 is typically a RAM for storing processed data. The frame memory 104 is used for storing video information for displaying a 3-dimensional space including a 3-dimensional model and a tool. The picture display unit 105 is used for displaying a video signal stored in the frame memory 104 on a display device. Representatives of the display device include a computer display unit and an HMD (head mount display) unit. The input unit 106 is used for inputting measurement values generated by a variety of input devices. The external storage unit 107 is used for storing programs and information on a 3-dimensional model.

The external storage unit 107 is a secondary storage device used for storing programs and information on a 3-dimensional model as described above. A representative of the secondary storage device is a hard disc. Information required in processing carried out by execution of a program can also be stored in the external storage unit 107. Examples of such information are information on a 3-dimensional model and the state of a tool which are stored also in the data memory 103.

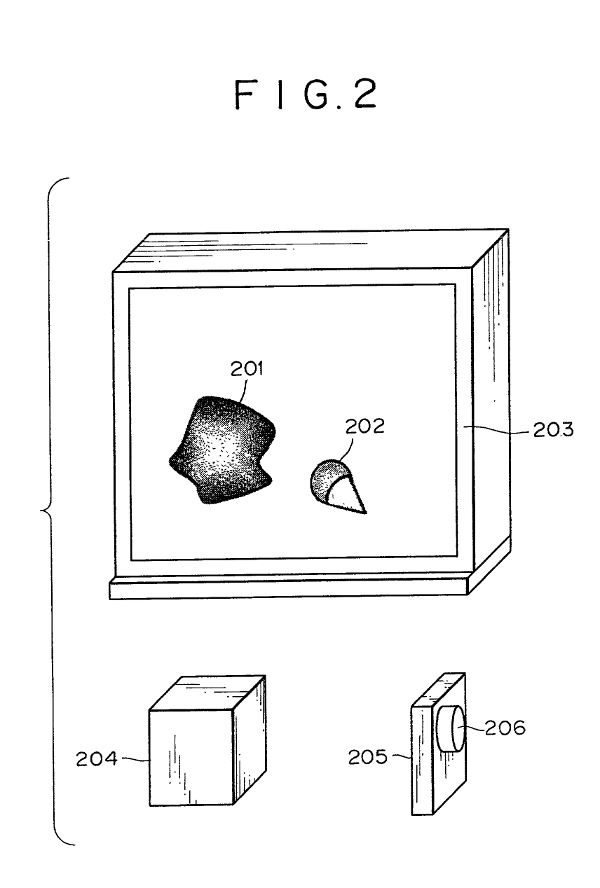

The input unit 106 acquires measurement values generated by a variety of input devices as described above. More specifically, the input unit 106 receives measurement values generated by a 3-dimensional input device such as a 3-dimensional sensor or a 3-dimensional mouse and used for updating the position and the posture of the tool. In the present invention, 3-dimensional sensors shown in FIG. 2 are used as a 3-dimensional input device. The operator is capable of changing the position and the posture of each of the 3-dimensional sensors. It should be noted that, instead of a 3-dimensional input device, a 2-dimensional input device such as a 2-dimensional mouse and a tablet can also be used. The input unit 106 also acquires an on/off state of a push button or the like. The input unit 106 acquires an on/off state of a simple push button, a mouse button, a keyboard button or an on/off switch, for example. In the following description, a phrase saying: “A button is pressed” means that the button transits from an off state to an on state. On the other hand, a phrase saying: “A button is released” means that the button reversely transits from an on state to an off state. A phrase saying: “A button is clicked” means that the button is released right after being pressed. A command entered by carrying out an operation to press, release or click a button is referred to as an event input.

The data memory 103 is used for storing various kinds of information on a 3-dimensional model including information on the position as well as the posture of the 3-dimensional model and information on surface attributes of the 3-dimensional model. Examples of the information on a 3-dimensional model are information on polygon or voxel expression and information on free-curved surfaces such as an NURBS.

The processing circuit 101 updates the position and the posture of a tool on the basis of measurement values obtained by the input unit 106. If necessary, the processing circuit 101 also updates information on 3-dimensional models, which is stored in the data memory 103. A tool employed in the 3-dimensional-model-processing apparatus is operated by using a 3-dimensional sensor assigned to the tool. The processing circuit 101 also carries out processing to change surface information of a displayed 3-dimensional model such as the shape and the color of the model appearing as a computer graphic. More specifically, the processing circuit 101 also changes information on attributes such as the color of the surface of the 3-dimensional model. The information on attributes is stored in the data memory 103.

FIG. 2 is a diagram showing a display of the 3-dimensional-model-processing system and typical configurations of 3-dimensional sensors 204 and 205. In the 3-dimensional-model-processing system, the tool-driving 3-dimensional sensor 205 having a button 206 is used to operate a tool 202 appearing on a monitor (display unit) 203 as a computer graphic. On the other hand, the model-driving 3-dimensional sensor 204 is used to operate a 3-dimensional model 201 appearing on the display unit 203 also as a computer graphic. The button 206 is operated typically for entering a command to start or halt processing carried out by the tool 202 or entering a variety of inputs such as setting of the type of the tool 202. It should be noted that, if another command and setting input means can be used as a substitute for the button 206 the tool-driving 3-dimensional sensor 205 may not necessarily need the button 206 In addition, the tool-driving 3-dimensional sensor 205 can be implemented in an arbitrary way. It is desirable, however, to provide the tool-driving 3-dimensional sensor 205 into an implementation that allows the operator to easily understand the functions thereof to be executed for carrying out processing such as pull and push processing.

By operating the model-driving 3-dimensional sensor 204, the operator is capable of arbitrarily changing information on the position as well as the posture of the 3-dimensional model 201 appearing on the display unit 203. By the same token, by operating the tool-driving 3-dimensional sensor 205, the operator is capable of arbitrarily changing information on the position as well as the posture of the tool 202 appearing on the display unit 203. The model-driving 3-dimensional sensor 204 and the tool-driving 3-dimensional sensor 205 can each be implemented by a magnetic or ultrasonic sensor generating a magnetic field or an ultrasonic wave respectively to represent information on a position and a posture. It should be noted that the tool-driving 3-dimensional sensor 205 may be replaced by, for example, another sensor having a dial or the like serving as a substitute for the button 206 In addition, if it is not necessary to move the 3-dimensional model 201, the model-driving 3-dimensional sensor 204 is not required as well. In this case, processing such as painting and deformation of the stationary 3-dimensional model 201 is carried out by operating only the tool-driving 3-dimensional sensor 205.

As described above, by operating the model-driving 3-dimensional sensor 204 and the tool-driving 3-dimensional sensor 205, it is possible to control the position as well as the posture of the 3-dimensional model 201 and the position as well as the posture of the tool 202 respectively. Information on a modified position and a modified posture, which is obtained as a result of an operation, is generated by the model-driving 3-dimensional sensor 204 or the tool-driving 3-dimensional sensor 205 and supplied to the processing circuit 101. The processing circuit 101 outputs the position as well as the posture of the 3-dimensional model 201 and the position as well as the posture of the tool 202 as information on attributes to update the position as well as the posture of the 3-dimensional model 201 and the position as well as the posture of the tool 202 on the display unit 203.

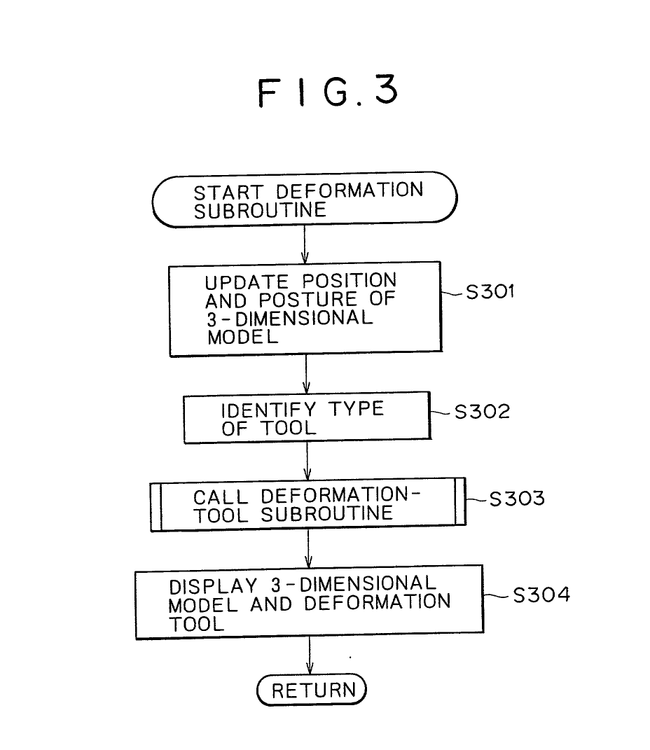

FIG. 3 is a flowchart representing a subroutine of the operation of a deformation tool for creating a protrusion and a dent on a 3-dimensional model. The deformation tool is an example of the processing tool. The deformation-tool subroutine is invoked by the 3-dimensional-model-processing system at time intervals or in the event of a hardware interrupt. With the deformation-tool subroutine not activated, the 3-dimensional-model-processing system may carry out processing other than the processing represented by the subroutine. In addition, the 3-dimensional-model-processing system is initialized before the deformation-tool subroutine is invoked for the first time.

The deformation-tool subroutine is explained by referring to the flowchart shown in FIG. 3. As shown in the figure, the flowchart begins with a step S301 at which the position and the posture of the 3-dimensional model are updated on the basis of measurement values obtained from the input unit 106. The flow of the subroutine then goes on to a step S302 at which the type of deformation tool is identified. The type of the 3-dimensional model is stored in the 3-dimensional-model-processing system as a tool state and can be changed by the user. At the next step S303, a deformation-tool subroutine is called to carry out processing according to the type of the 3-dimensional model. At the last step S304, the 3-dimensional model and the deformation tool are displayed on the display unit.

The deformation-tool subroutine called at the step S303 is further exemplified by the embodiments as follows.

First Embodiment

A first embodiment implements a method to specify a position on a 3-dimensional model to be deformed and deform the position by using a deformation tool. In the 3-dimensional-model-processing apparatus provided by the present invention, processing is carried out on a 3-dimensional model by operating the model-driving 3-dimensional sensor 204, that is, one of the sensors provided for the 3-dimensional model being processed. On the display unit, the 3-dimensional model is moved and/or rotated. On the other hand, processing is also carried out on a tool by operating the tool-driving 3-dimensional sensor 205, that is, the other sensor provided for the tool. On the display unit, the tool is moved and/or rotated.

On the display unit, an operating point is defined for a deformation tool. Computation of deformation processing state variables is based on a relation with the defined operating point. An operating point may be defined at the same position as the deformation tool or a position different from the location of the tool, for example, a position separated away from the location by a predetermined distance. The configuration of the 3-dimensional-model-processing system allows the user to modify the position of an operating point or an operating area to be described later. The configuration allows the relation between a set operating point and the position of the deformation tool to be fixed or to be dynamically changed in accordance with the circumstance. For example, assume that an operating point (x, y, z) is set at a position computed on the basis of a tool position (x (t), y (9), z (t)). In this case, the 3-dimensional-model-processing system can be designed into a configuration wherein the operating point is found as a function of tool position, that is, the operating point (x, y, z)=f(x (t), y (9), z (t)). In addition, by providing a configuration wherein the area of the movement of the operating point is limited to the surface of the 3-dimensional model being processed, processing can be carried out more easily. Processing to constrain an operating point on the surface of a 3-dimensional model will be described later.

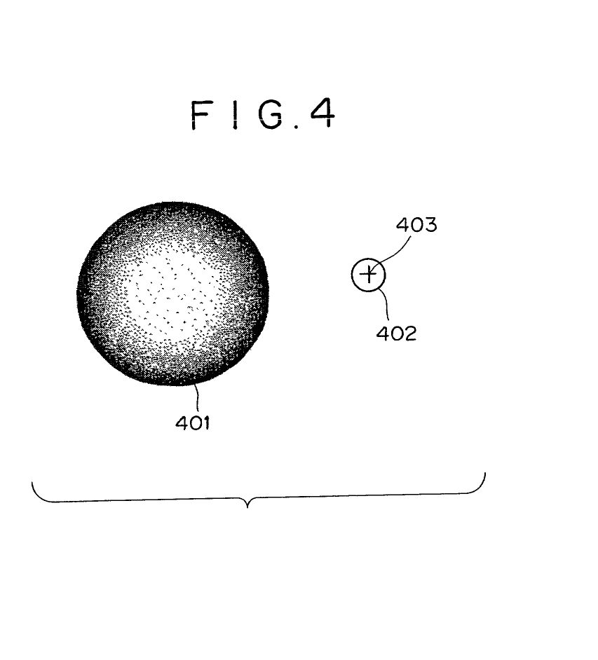

FIG. 4 is a diagram showing an example of setting an operating point. FIG. 4 shows a configuration of processing to be carried out on a 3-dimensional model by using a push-pull deformation tool as a tool for forming a dent and/or a protrusion on the 3-dimensional model. As shown in the figure, the configuration comprises a 3-dimensional model 401 and a tool 402, which appear on a display unit, as is the case with the configuration shown in FIG. 2. As described earlier by referring to FIG. 2, the 3-dimensional model 401 can be moved and/or rotated by operating a 3-dimensional sensor assigned to the 3-dimensional model 401. By the same token, the tool 402 can be moved and/or rotated by operating a 3-dimensional sensor assigned to the tool 402.

In the 3-dimensional-model-processing apparatus provided by the present invention, an operating point 403 is defined at the tool 402. The operating point 403 is used to specify a position on the surface of the 3-dimensional model 401 to be deformed. By pressing a button provided on a 3-dimensional sensor assigned to the tool 402, a deformation mode is established to start deformation processing. The 3-dimensional model 401 is deformed in accordance with a movement of the tool 402 till the button is released to exit from the deformation mode. By displaying the operating point 403 on the display unit, the operator is capable of knowing what point the deformation by using the tool 402 is carried out at. As a result, processing of the 3-dimensional model 401 can be carried out easily with a high degree of accuracy.

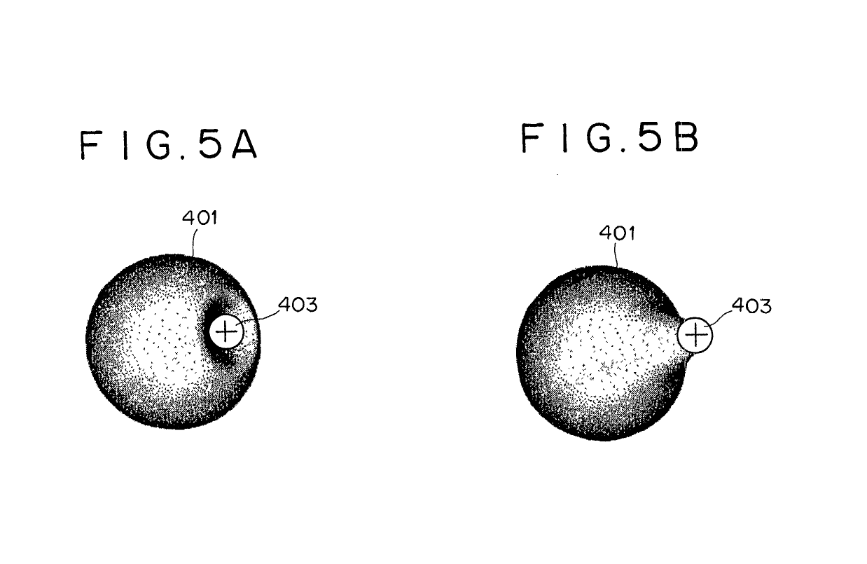

FIGS. 5A and 5B are diagrams each showing an example of the deformation processing. The deformation processing is centered at the configuration portion of the push-pull deformation tool itself or centered at an operating point set and displayed at a position in close proximity to the tool. The surface of the 3-dimensional model 401 is pushed in by the tool 402 as shown in FIG. 5A or is pulled out by the tool 402 as shown in FIG. 5B in various kinds of deformation processing centered at the operating point 403. The operator is capable of easily knowing a point on the surface of the 3-dimensional model 401, with which the operating point 403 is brought into contact, as a processing point. Thus, the deformation processing can be carried out by means of a sense as if a piece of clay were actually deformed without an error in recognition of the processing position. In the examples shown in FIGS. 4, 5A and 5B are 3-dimensional model is assumed to have a spherical pre-deformation shape for making the explanation simple. It should be noted, however, that the 3-dimensional model can have any arbitrary shape.

In addition, in order to make a position on the surface of a 3-dimensional model easy to specify, it is possible to provide a configuration for limiting a domain of an operating point on the surface of a 3-dimensional model in an operation to specify the operating point on the surface of the 3-dimensional model. That is to say, control is executed so as to allow an operating point to move only over the surface of a 3-dimensional model. As a technique for constraining the movement of an operating point on the surface of a 3-dimensional mode, it is possible to adopt a method described in detail in a patent application submitted by the inventor of the present invention. In accordance with this method, there is provided a configuration wherein a point is set on the surface at an intersection of the surface of a 3-dimensional model and a line connecting the position of a tool to a location occupied by the tool at the preceding execution. The point on the surface is moved sequentially in accordance with the movement of the tool. A state in which the movement of an operating point is constrained on the surface of a 3-dimensional model is referred to as a constrained-movement mode. On the other hand, a state in which the movement of an operating point is not constrained on the surface of a 3-dimensional model is referred to as a free-movement mode.

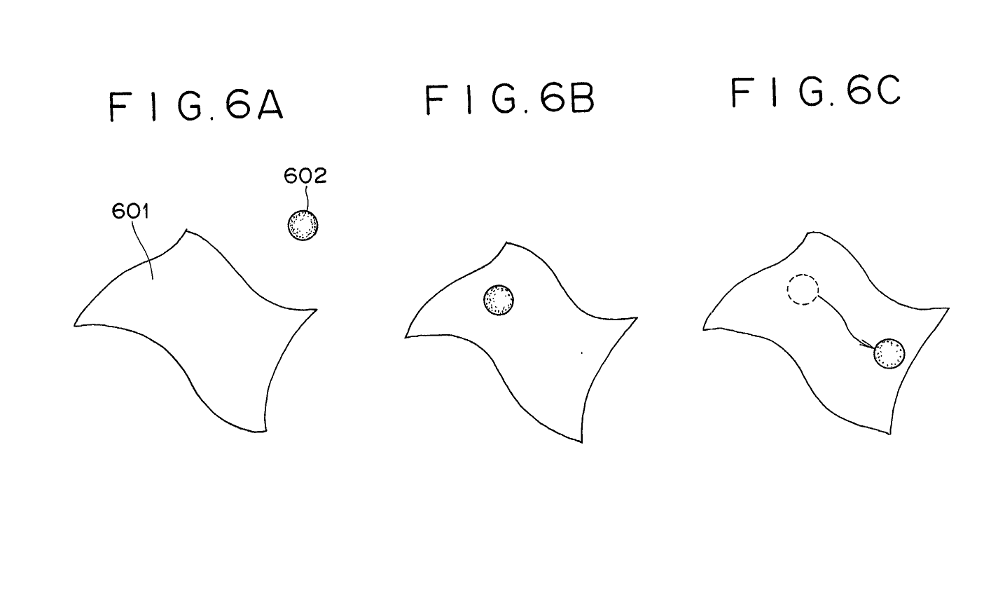

Control configurations in the constrained-movement mode and the free-movement mode are explained by referring to FIGS. 6A through 6C and subsequent figures. FIG. 6A is a diagram showing definitions of a 3-dimensional model 601 and an operating point 602. In an operation to specify a point on the surface of a 3-dimensional model 601 by using an operating point 602, the operating point 602 is made incapable of passing through the surface of the 3-dimensional model 601 and stopped on the surface at a position hit by the operating point 602. In this way, the movement of the position of the operating point is constrained on the surface of the 3-dimensional model 601 as shown in FIG. 6B. The side on which the operating point 602 existed prior to the operation to stop the operating point on the surface of the 3-dimensional model 601 is referred to as a front side. The side opposite to the front side with respect to the surface of the 3-dimensional model 601 is referred to as a back side.

In a relation with the surface of the 3-dimensional model 601, the position of the operating point 602 in an unconstrained state is referred to as a reference point. A point on the surface of the 3-dimensional model 601 is controlled on the basis of a reference point. Such a controlled point on the surface of the 3-dimensional model 601 is referred to as a surface point for the reference point. Thereafter, the operating point moves continuously by sliding over the surface of the 3-dimensional model 601 as shown in FIG. 6C in dependence on the movement of the reference point till a condition gets satisfied. An example of a satisfied condition is the fact that the reference point is returned to the front side.

An algorithm adopted by the embodiment is explained in detail by referring to a flowchart and a model diagram.

Surface-Point Subroutine

A surface-point subroutine generates a surface point when a specific condition is satisfied. An example of a satisfied specific condition is an event in which the operating point 602 passes through the surface of the 3-dimensional model 601. The created surface point is taken as a tentative position of the operating point 602. Thus, the operating point 602 appears to have been stopped at the tentative position on the surface of the 3-dimensional model 601. The surface point is then updated by the surface-point subroutine in accordance with the movement of the reference point so that the surface point moves continuously over the surface of the 3-dimensional model 601.

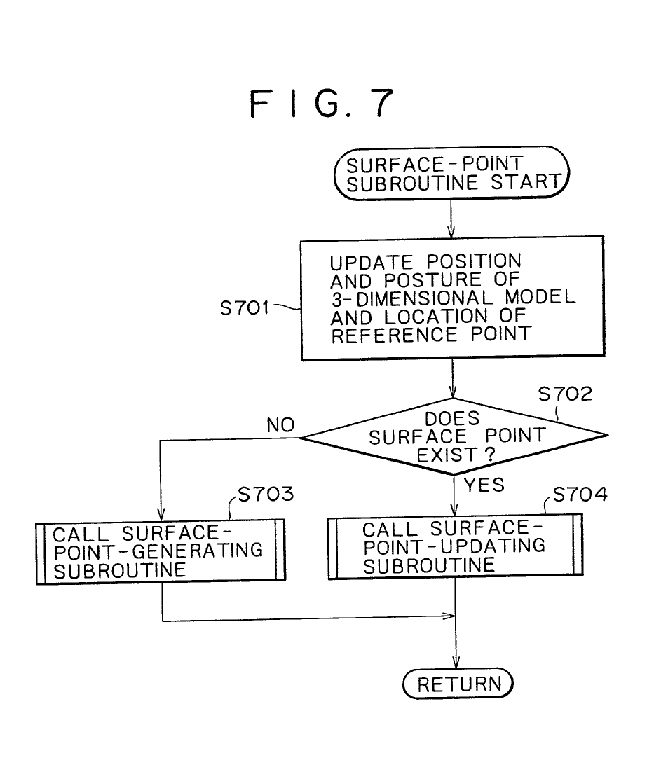

FIG. 7 shows a flowchart representing the surface-point subroutine for setting a surface point for an operating point by adoption of a method implemented by this embodiment. The surface-point subroutine is invoked by the 3-dimensional-model-processing system at time intervals or in the event of a hardware interrupt. With the surface-point subroutine not activated, the 3-dimensional-model-processing system may carry out processing other than the processing represented by the subroutine. In addition, the 3-dimensional-model-processing system is initialized before the surface-point subroutine is invoked for the first time.

An outline of the surface-point subroutine is explained by referring to the flowchart shown in FIG. 7.

The 3-dimensional-model-processing system is initialized with a surface point for the reference point not existing before the surface-point subroutine is invoked for the first time. As shown in FIG. 7, the surface-point subroutine starts with a step S701 at which the position as well as the posture of a 3-dimensional model and the position of a reference point are updated. The operation to update the positions and the posture is based on input information received from the model-driving 3-dimensional sensor 204 and the tool-driving 3-dimensional sensor 205, which are shown in FIG. 2. It should be noted that another configuration using only the tool-driving 3-dimensional sensor 205 without the model-driving 3-dimensional sensor 204 can also be provided. In such a configuration, processing is carried out by operating only the tool-driving 3-dimensional sensor 205 with the position of the 3-dimensional model on the display unit fixed. In addition to the model-driving 3-dimensional sensor 204 and the tool-driving 3-dimensional sensor 205 shown in FIG. 2, the positions and the posture can also be updated by operating an input device such as a keyboard or a mouse. As another alternative, the positions and the posture can also be updated by other means such as generation of time-axis data defined in advance to represent the positions and the posture.

The flow of the subroutine then goes on to a step S702 to form a judgment as to whether or not a surface point for the reference point exists. If a surface point does not exist, the flow of the subroutine goes on to a step S703 to call a surface-point-generating subroutine for determining whether a surface point is to be generated. If a condition for generation of a surface point is satisfied, the surface point is generated. If the outcome of the judgment formed at the step S702 indicates that a surface point for the reference point exists, on the other hand, the flow of the subroutine goes on to a step S704 to call a surface-point-updating subroutine for updating the position of the surface point. If necessary, the surface point is deleted.

The surface-point-generating subroutine called at the step S703 and the surface-point-updating subroutine called at the step S704 are explained in detail as follows.

Surface-Point-Generating Subroutine

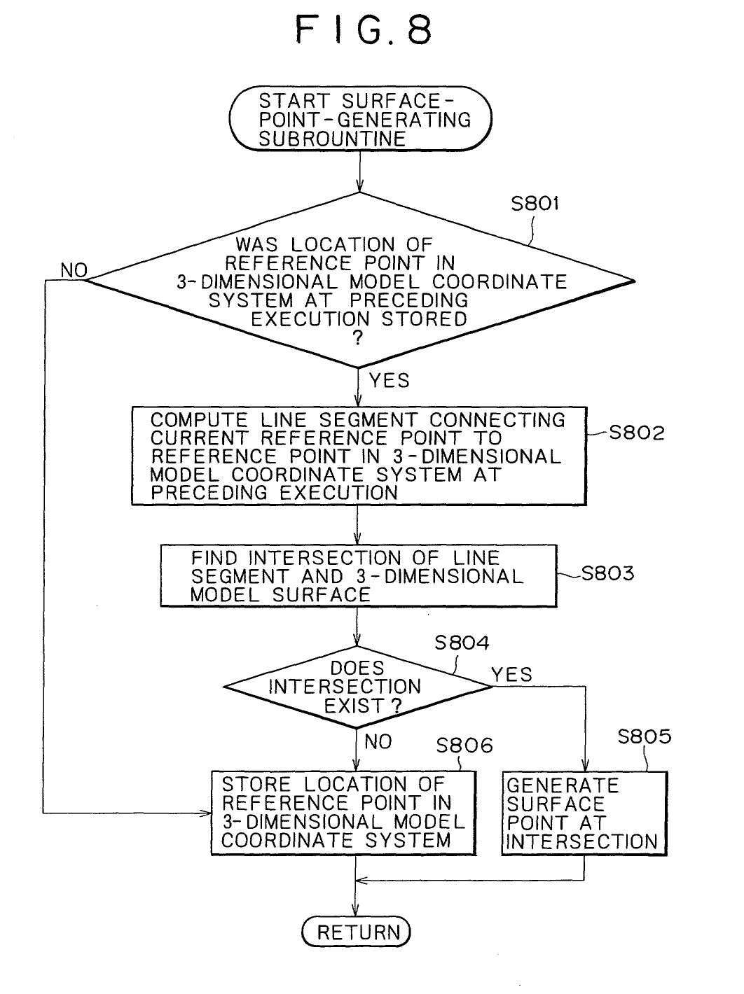

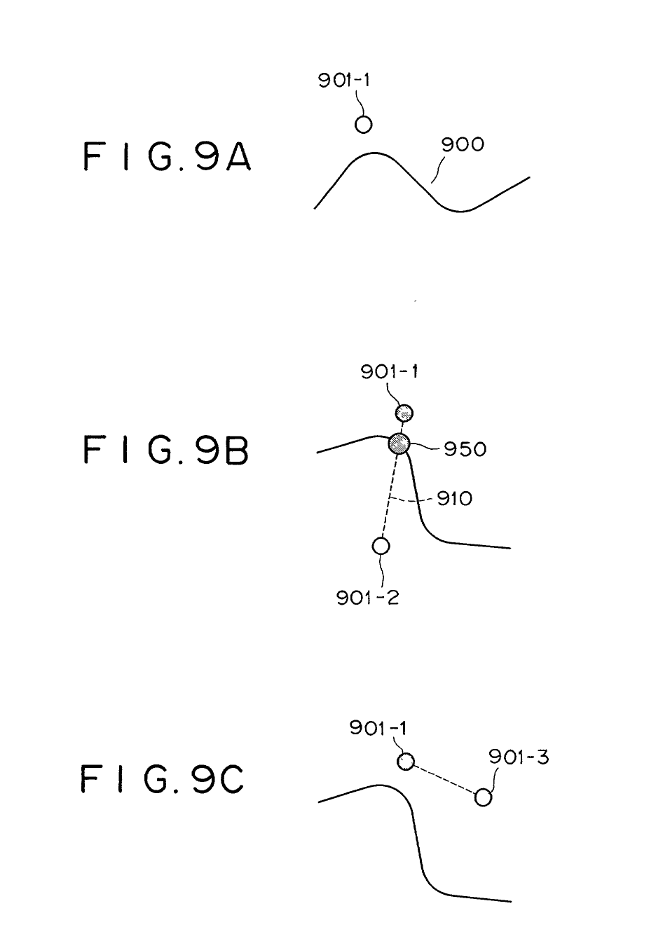

FIG. 8 shows a flowchart representing the surface-point-generating subroutine of this embodiment. FIGS. 9A through 9C are diagrams each showing a model used for explaining the surface-point-generating subroutine. The surface-point-generating subroutine is explained by referring to these figures as follows.

As shown in FIG. 8, the surface-point-generating subroutine begins with a step S801 to form a judgment as to whether or not information on the position of a reference point in a 3-dimensional coordinate system at the preceding execution is stored in a memory. The 3-dimensional coordinate system is a coordinate system established with the processed 3-dimensional model serving as a center. Normally, if this surface-point-generating subroutine is called for the first time, no such information is stored. If no such information is stored, the flow of the subroutine goes on to a step S806 at which the position of an operating point is stored as the position of a reference point. The subroutine is then ended.

Processing is explained by referring to the model diagrams shown in FIGS. 9A through 9C. At a certain point of time, a reference point 901-1 for a 3-dimensional model 900 exists at a position shown in FIG. 9A. As described earlier, the reference point 901-1 is an operating point with no constraints. At the next step, the operator operates a model-driving 3-dimensional sensor or a tool-driving 3-dimensional sensor to change the position and the posture of the 3-dimensional model 900 relative to the reference point as shown in FIG. 9B.

The reference point 901-1 moves relatively to the 3-dimensional model 900. The reference point 901-1 shown in FIG. 9B is a position of the reference point in the same 3-dimensional model coordinate system as that shown in FIG. 9A. On the other hand, a reference point 901-2 is a position of the reference point in the current 3-dimensional model coordinate system. In the following figures, a white circle denotes the current position of the reference point. On the other hand, a black circle is the position of the reference point at the preceding execution. With the reference point brought to the position shown in FIG. 9B, at a step S802 of the flowchart shown in FIG. 8, a line segment 910 is drawn to connect the reference point 901-1 or the position of the reference point in the 3-dimensional model coordinate system at the preceding execution to the reference point 901-2 and the current position of the reference point 901-2 in the 3-dimensional model coordinate system. At the next step S803, an intersection of the line segment 910 drawn at the step S802 and the surface of the 3-dimensional model 900 is found. The flow of the subroutine then goes on to a step S804 to form a judgment as to whether or not such an intersection exists. If such an intersection exists, the flow of the subroutine goes on to a step S805 at which a surface point 950 is newly generated at the intersection. That is to say, if the reference point passes through the surface of the 3-dimensional model 900, a surface point 950 is generated at a position passed through by the reference point.

It should be noted that, when the reference point has moved relatively to the 3-dimensional model 900 as shown in FIG. 9C, on the other hand, the outcome of the judgment formed at the step S804 will indicate such an intersection does not exist. In this case, the flow of the subroutine goes on to a step S806 at which the current position of the reference point in the 3-dimensional model coordinate system, that is, the reference point 901-3 shown in FIG. 9C, is stored.

Surface-Point-Updating Subroutine

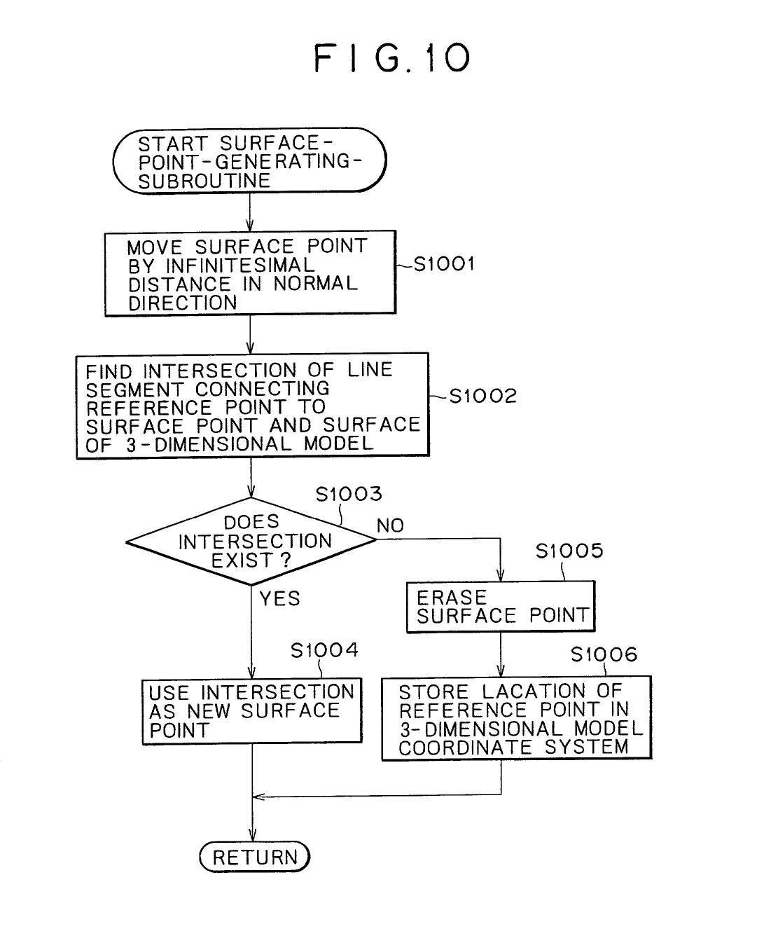

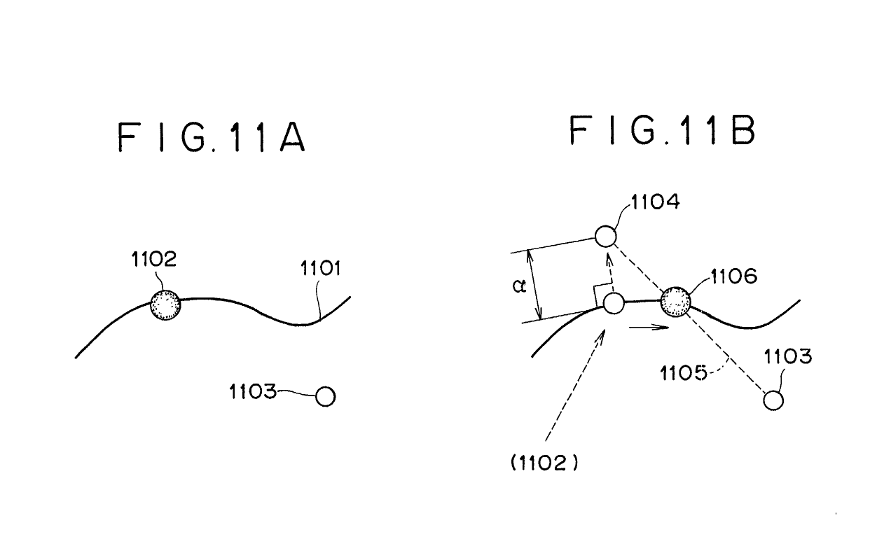

FIG. 10 is a flowchart representing the surface-point-updating subroutine of this embodiment. FIGS. 11A and 11B are diagrams each showing a model used for explaining the surface-point-updating subroutine. The surface-point-updating subroutine is explained by referring to these figures as follows.

Assume a 3-dimensional model 1101 with a surface shown in FIGS. 11A and 11B. Let a surface point 1102 be set on the surface for an operating point. Also assume that a current reference point 1103 is set at the position of a tool. In this case, an algorithm to update the surface point for the operating point works as follows.

As shown in FIG. 10, the flowchart begins with a step S1001 at which the surface point 1104 is moved in the direction normal to the surface of the 3-dimensional model 1101 by an appropriate distance shown in FIG. 11B. The distance may be found from experiences or changed dynamically in accordance with the circumstance. Then, at the next step S1002, a line segment 1105 is drawn to connect the current reference point 1103 to the surface point 1104 moved to the next location as shown in FIG. 11B, and an intersection of the line segment 1105 and the surface of the 3-dimensional model 1101 is found. The flow of the subroutine then goes to the next step S1003 to form a judgment as to whether or not such an intersection exists. If such an intersection exists, the flow of the subroutine goes on to a step S1004 at which the intersection is taken as a new surface point 1106. If the outcome of the judgment formed at the step S1003 indicates that no intersection exists, on the other hand, the flow of the subroutine goes on to a step S1005 at which the surface point is deleted. Then, at the next step S1006, the position of the reference point in the 3-dimensional model coordinate system is stored for use in the surface-point-generating subroutine called at the next execution.

By carrying out the aforementioned processing to generate a surface point and the aforementioned processing to update the surface point for an operating point as described above, the operating point set on the surface of the 3-dimensional model slides over the surface of the 3-dimensional model, moving to another position on the surface. Assume that an operating point moving over the surface of such a 3-dimensional model is set as an operating point applicable to a deformation tool. In this case, when the operator moves the tool to a position in close proximity to the 3-dimensional model, the operating point also moves, sliding over the surface of the 3-dimensional model. Thus, processing to deform the 3-dimensional model such as processing to form a dent or a protrusion in a specific area on the surface of the 3-dimensional model can be carried out with ease and with a high degree of accuracy. In addition, if the tool is set as a paint tool, for example, processing to draw characters on the surface of a 3-dimensional model or add a pattern to another pattern can also be carried out accurately.

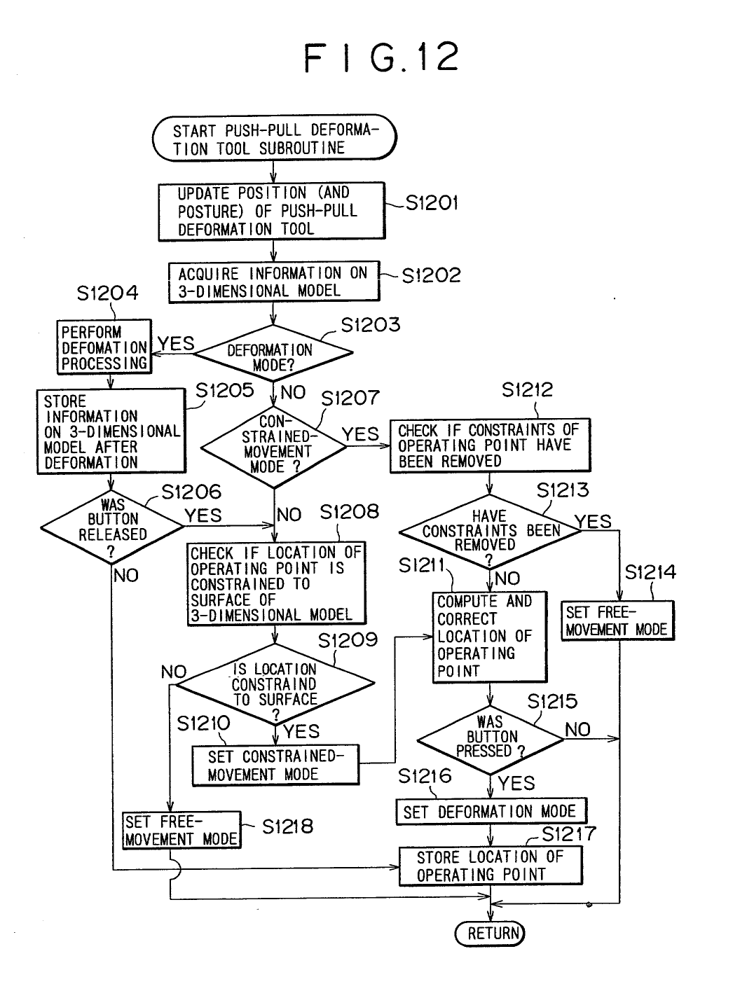

FIG. 12 shows a flowchart representing processing carried out by using a push-pull deformation tool in the 3-dimensional-model-processing apparatus provided by the present invention. The processing is explained by referring to the flowchart as follows. As shown in the figure, the flowchart begins with a step S1201 at which the position and the posture of the push-pull deformation tool are updated. The update processing is based on the position of a 3-dimensional sensor which can be operated by the operator as described earlier by referring to FIG. 2. In this update processing, an operating point attached to the push-pull deformation tool is updated. If the operating point has been set at the same position as the push-pull deformation tool, however, it is not necessary to carry out the processing to update the operating point as a separate process. In addition, if the shape of the push-pull deformation tool is independent of the posture of the tool, it is not necessary to update the posture of the tool. An example of the posture-independent shape of the push-pull deformation tool is a spherical tool.

At the next step S1202, information on a 3-dimensional model is acquired. The flow of the subroutine then goes on to the next step S1203 to form judgment as to whether or not the processing mode is a deformation mode. If the processing mode is not a deformation mode, the flow of the subroutine goes on to a step S1207 to form a judgment as to whether or not the processing mode is a constrained-movement mode which is a mode of constraining the movement of an operating point on the surface of a 3-dimensional model. If the processing mode is not a constrained-movement mode, the flow of the subroutine goes on to a step S1208 to examine whether or not a condition determined in advance in the 3-dimensional-model-processing system for constraining the movement of an operating point on the surface of a 3-dimensional model is satisfied. To be more specific, the constraint condition is examined to form a judgment as to whether or not the operating point has passed through the surface of the 3-dimensional model or whether or not the operating point set at a position on the tool itself or a position in close proximity to the tool has approached the surface of the 3-dimensional model to a certain degree, that is, whether the operating point is located at a distance from the surface of the 3-dimensional model shorter than a predetermined threshold value. That is to say, if a condition determined in advance is satisfied, the operating point can be set on the surface of the 3-dimensional model.

The flow of the subroutine then goes on to the next step S1209 to form a judgment as to whether or not to constrain the position of the operating point on the surface of the 3-dimensional model. The formation of the judgment is based on a result of the examination obtained at the step S1208. If the position of the operating point is not constrained, the flow of the subroutine goes on to a step S1218 at which a free-movement mode is established. If the position of the operating point is to be constrained, the flow of the subroutine goes on to a step S1210 at which the constrained-movement mode is established. At the next step S1211, a position of the operating point on the surface of the 3-dimensional model is computed and the location of the push-pull deformation tool is corrected to such a value that the operating point moves to the computed position.

If the outcome of the judgment formed at the step S1207 indicates that the operating point has already put in a constrained-movement mode, on the other hand, the flow of the subroutine goes on to a step S1212 to examine a condition determined in advance in the 3-dimensional-model-processing system for removing the constraints. The condition is examined to form a judgment as to, among others, whether or not the position in a state with no constraints of the operating point has been moved to a location on the front side or whether or not the position of the operating point has been moved to a location on the front side at least at a certain distance from the surface of the 3-dimensional model. The position in a state with no constraints of the operating point is a position at the time the processing of the step S1201 is carried out. As described earlier, the front side is a pre-constraint side with respect to the surface of the 3-dimensional model. The flow of the subroutine then goes on to the next step S1213 to form a judgment as to whether or not to remove the constraints. The formation of the judgment is based on a result of the examination obtained at the step S1212. If the constraints are to be removed, the flow of the subroutine goes on to a step S1214 at which a free-movement mode is established before the subroutine is ended. If the constraints are not to be removed, on the other hand, the flow of the subroutine goes on to the step S1211 at which a position of the operating point on the surface of the 3-dimensional model is computed and the location of the push-pull deformation tool is corrected to such a value that the operating point moves to the computed position.

After the position of the operating point is corrected at the step S1211 to a location on the surface of the 3-dimensional model in the constrained-movement mode, the flow of the subroutine goes on to a step S1215 to form a judgment as to whether or not a button of a 3-dimensional sensor assigned to the push-pull deformation tool has been pressed. If the button has been pressed, the flow of the subroutine goes on to a step S1216 at which a deformation mode is established. At the next step S1217, the operating point's present position required for deformation processing to be carried out at the following execution is stored.

If the outcome of the judgment formed at the step S1203 indicates that the processing mode is a deformation mode, on the other hand, the flow of the subroutine goes on to a step S1204 at which the actual processing is carried out and a result of the processing is stored at the next step S1205. In the actual processing, the 3-dimensional model is deformed by the operator by typically moving the 3-dimensional sensor assigned to the push-pull deformation tool. Then, the flow of the subroutine goes on to a step S1206 to form a judgment as to whether or not the button of a 3-dimensional sensor assigned to the push-pull deformation tool has been released. If the button of the 3-dimensional sensor assigned to the push-pull deformation tool has been released, the flow of the processing goes on to the step S1208. If the button of the 3-dimensional sensor assigned to the push-pull deformation tool is still being pressed as it is, on the other hand, the flow of the processing goes on to the step S1217 at which the operating point's present position required for deformation processing to be carried out at the following execution is stored.

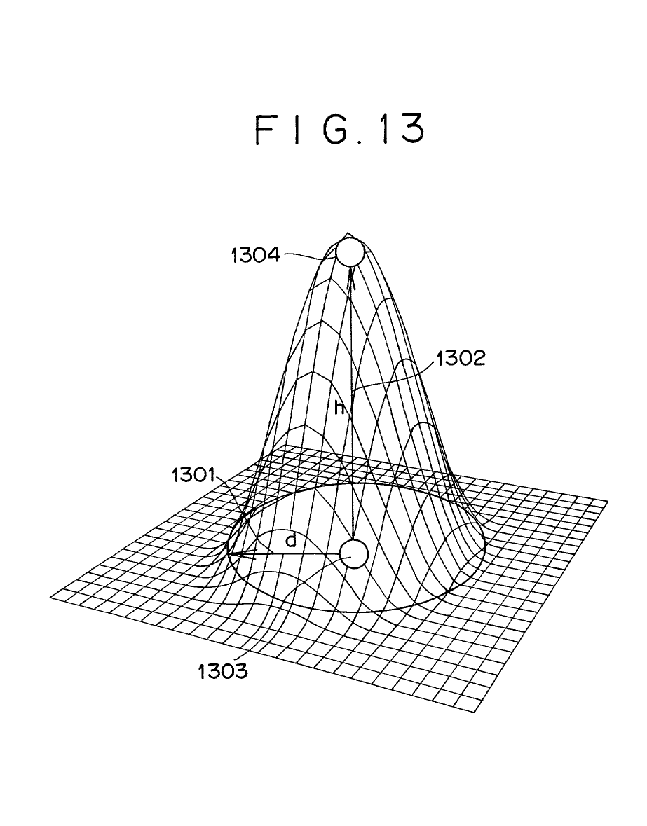

Typically, a technique known as an FFD is adopted in the concrete deformation processing carried out at the step S1204 of the flowchart shown in FIG. 12. A general FFD technique is explained briefly as follows. In accordance with this technique, a 3-dimensional model itself is not deformed directly. Instead, a space in which a 3-dimensional model exists is first set and the space is then deformed. The 3-dimensional model is deformed in accordance with a distortion developed in the space. An example of the deformation is shown in FIG. 13. The push-pull deformation tool serving as a deformation processing tool is provided with 2 parameters each representing an attribute. One of the parameters is a parameter d representing a range of deformation. This parameter d is denoted by reference numeral 1301 in FIG. 13. The other parameter h represents a line segment connecting a deformation center 1303 to a point 1304 expressing the direction and the strength of the deformation. The other parameter h is denoted by reference numeral 1302 in FIG. 13. Assume that a space having a z axis thereof coinciding with the direction of the h parameter 1302 is defined. In this case, the space is deformed in accordance with the following function in order to deform the surface of a 3-dimensional model.

$$Δ z = hE {ⅇ}^{- ( \frac{{x}^{2} \{ {y}^{2}}{{d}^{2}} )} \qquad \text{[Expression 1]}$$

In this case, smaller the d parameter 1301, the sharper the deformation. It should be noted that the FFD method is described in detail in “Advanced Animation and Rendering Techniques-Theory and Practice” authored by Alan Watt. et al., ACM Press, pp. 401-403, 1992.

In the case of the embodiment of the present invention, the deformation center 1303 is a position of an operating point stored at the step S1217 at the preceding execution (or a position at an offset therefrom) and the point 1304 is the current position of the operating point (or a position at an offset therefrom) in order to implement the deformation. The d parameter 1301 may be determined from experiences or changed properly in accordance with the circumstance. If the deformation is continuing for a plurality of executions, the deformation technique can be adopted continuously as well. If the 3-dimensional model is a polygon model, the vertex thereof is moved. If the polygon becomes too big, the polygon may be reconstructed if necessary.

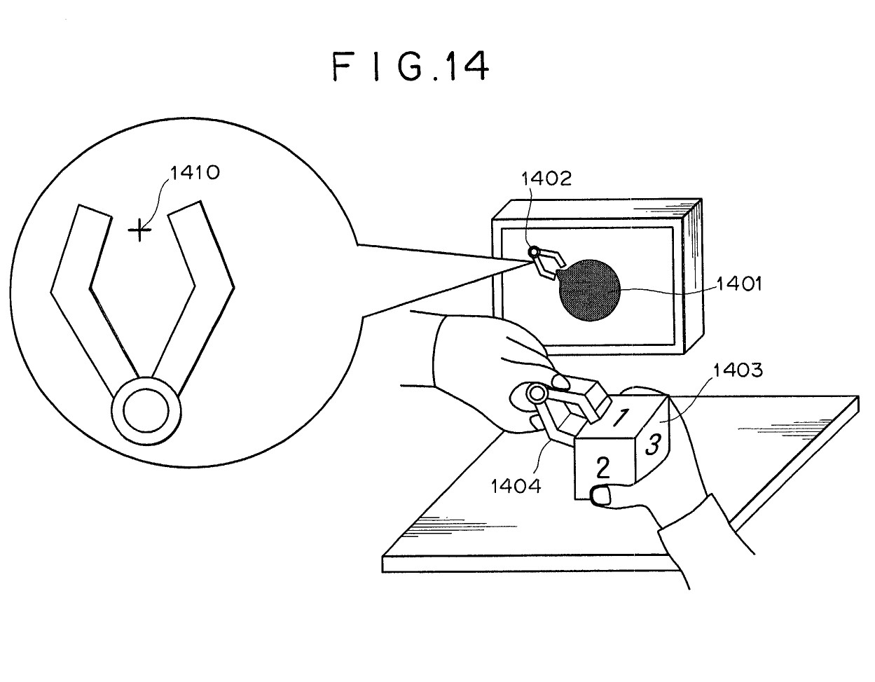

In the examples shown in FIGS. 4 and 5, the deformation tool has a spherical shape and the operating point is located at the center of the sphere. It should be noted, however, it is also possible to provide a configuration wherein the operating point is positioned on a portion of the deformation tool or set at a location in close proximity to the tool. FIG. 14 is a diagram showing a configuration wherein the operating point is set at a location in close proximity to the tool. A tool shown in FIG. 14 is a pinch tool used as a deformation tool for carrying out deformation by pulling. As shown in FIG. 14, a display unit exhibits a 3-dimensional model 1401 being processed and a pinch tool 1402 used as a deformation tool. On the display, an operating point 1410 is set at a position in close proximity to the pinch tool 1402. As shown in the figure, the operating point 1410 is set in the middle of an edge of the pinch tool 1402. The operator operates a 3-dimensional sensor 1403 assigned to the 3-dimensional model 1401 and a 3-dimensional sensor 1404 assigned to the pinch tool 1402 to move the 3-dimensional model 1401 relatively to the pinch tool 1402 used as the deformation tool.

In the processing of the pinch tool 1402 shown in FIG. 14, the operating point 1410 is placed at a predetermined position of the 3-dimensional model 1401 and, then, an operation is carried out to close the tool-driving 3-dimensional sensor 1404 assigned to the pinch tool 1402 wherein the tool-driving 3-dimensional sensor 1404 has an actual pinch shape with a configuration wherein a processing start point is set under the condition that the tool-driving 3-dimensional sensor 1404 assigned to the pinch tool 1402 has been closed to at least a certain degree. Thus, the operator is capable of carrying out a pinch operation by means of a sense of operating a real pinch tool.

Processing such as deformation and painting, which are carried out by using a variety of tools, can be started and ended by entering a command via a button provided on a 3-dimensional sensor assigned to a 3-dimensional model. It should be noted, however, that means for entering such a command does not have to be a button. It is also possible to provide a configuration wherein a command is entered by using another input means, keys of a keyboard or a dial provided on a sensor, or indicated as a tool behavior driven by an operation of a sensor assigned to the tool.

As a configuration wherein processing is started and ended not by a command entered by operating a button, there is a push-tool configuration for pushing the surface of a 3-dimensional model as shown in FIGS. 5A and 5B. With the push tool shown in FIGS. 5A and 5B, as soon as an operating point appearing on the display unit comes in contact with a 3-dimensional model, the surface of the 3-dimensional model is deformed (or to be more specific, indented) in accordance with the movement of the operating point. That is to say, in the case of a press tool, processing is started at a point of time the position of the operating point coincides with the position coordinate of the surface of the 3-dimensional model.

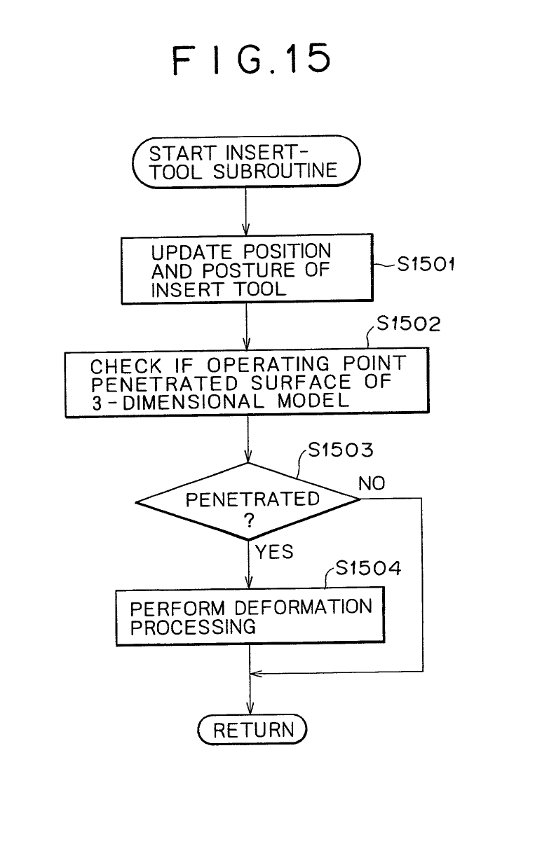

FIG. 15 shows a flowchart representing processing of the push tool shown in FIGS. 5A and 5B. As shown in FIG. 15, the flowchart begins with a step S1501 at which the position and the posture of the push tool are updated. The update processing is based on data representing the position and the posture of a 3-dimensional sensor assigned to the push tool. Then, at the next step S1502, a relation between the locus of the operating point and the surface of the 3-dimensional model is traced. The flow of the subroutine then goes on to a step S1503 to form a judgment as to whether or not the operating point penetrated the surface. If the operating point penetrated the surface, the flow of the subroutine goes on to a step S1504 at which the deformation processing is actually carried out.

Typically, the concrete deformation processing is carried out at the step S1504 of the flowchart shown in FIG. 15 as FFD deformation shown in FIG. 13. A position on the surface of the 3-dimensional model (or a position at an offset therefrom) passed through by the push tool is taken as a deformation center 1303. On the other hand, the position of an operating point (or a position at an offset therefrom) is taken as a point 1304 representing the direction and the strength of the deformation.

Second Embodiment

The first embodiment is used for exemplifying a case in which an operating point is set as a single point. On the other hand, a configuration for setting a spread operating area is explained as a second embodiment as follows.

In the case of the second embodiment, there is provided a configuration wherein a tool having an operating area is operated by using a 3-dimensional sensor which includes a button. A surface area on the 3-dimensional model is formed, being superposed on the operating area. It is desirable to show the operating area on the display unit in order to make the operating area easy to understand. The 3-dimensional model's surface area superposed on the operating area is referred to as a deformation area.

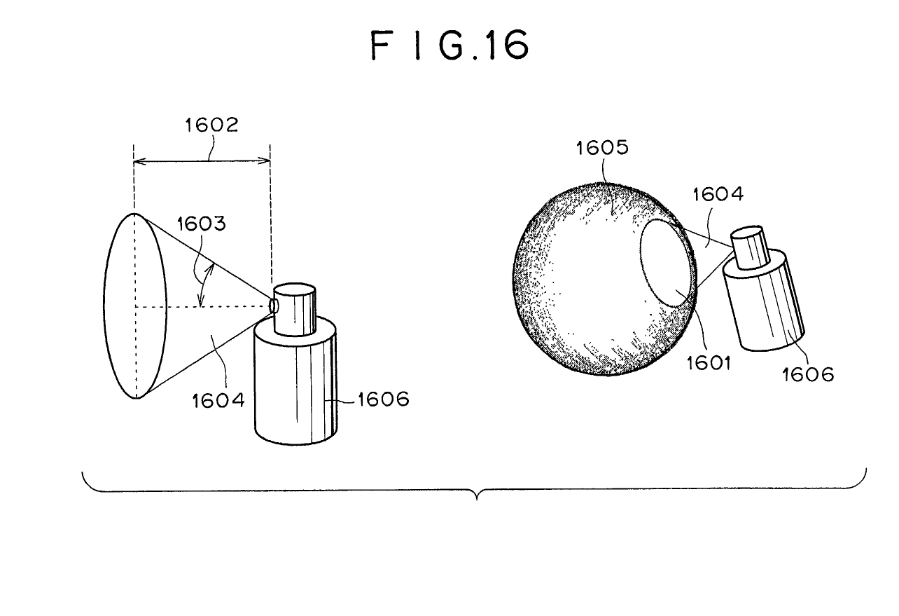

Assume for example a deformation-processing configuration wherein a spray can like one shown in the left diagram of FIG. 16 is set as a spray tool 1606. On the spray tool 1606, an operating area 1604 having a conical shape is defined. The operating area 1604 is defined by parameters representing its length 1602 and its angle 1603. By changing these parameters, the operating area 1604 can be modified. The operating area 1604 of the spray tool 1606 is moved to a location to be deformed. A deformation area 1601 is defined as an overlap of the surface of a 3-dimensional model 1605 and the operating area 1604. The surface of the deformation area 1601 is either pulled or pushed in accordance with information on the area of the deformation area 1601, information on the position of the operating area 1604 and information on the posture of the spray tool 1606.

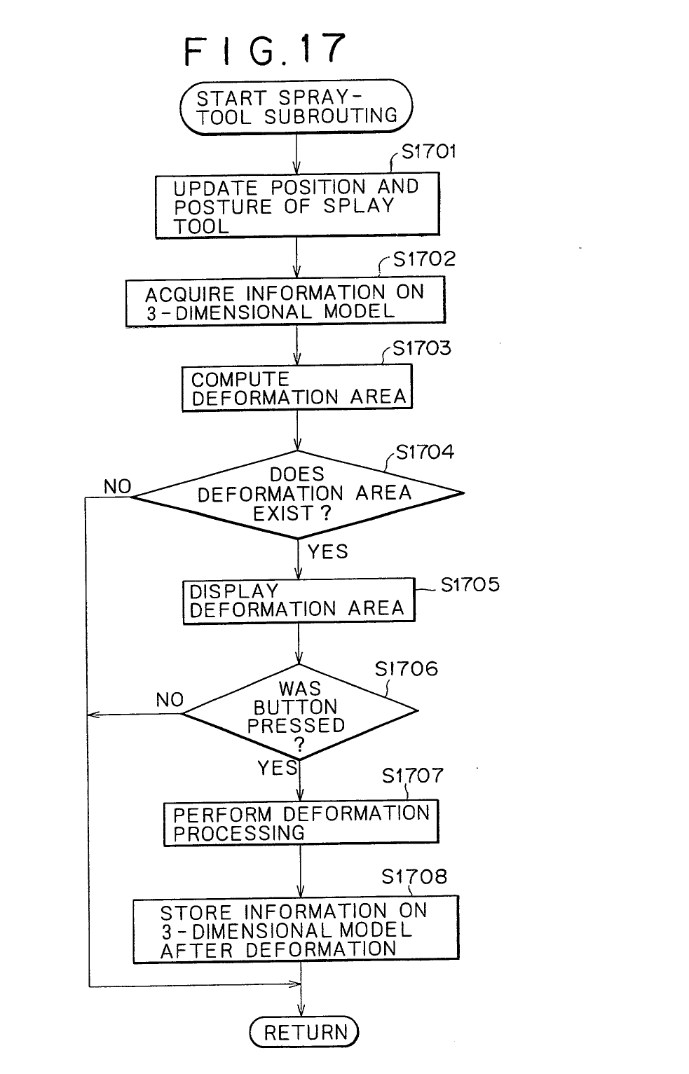

FIG. 17 shows a flowchart representing processing of the spray tool shown in FIG. 16. As shown in the figure, the flowchart begins with a step S1701 at which the position and the posture of the spray tool are updated. Thus, the spray tool and its operating area are moved and rotated. At the next step S1702, information on a 3-dimensional model is acquired. At the next step S1703, the operating area of the spray tool and an overlap area on the 3-dimensional model are computed to find a deformation area. The flow of the subroutine then goes on to a step S1704 to form a judgment as to whether or not a deformation area exists. If a deformation area exists, the flow of the subroutine goes on to a step S1705 at which the deformation area is displayed. It should be noted that the processing carried out at the step S1705 can be omitted. If the outcome of the judgment formed at the step S1704 indicates that a deformation area does not exist, on the other hand, the routine is ended. After the step S1705, the flow of the subroutine goes on to a step S1706 to form a judgment as to whether or not the button has been pressed. If the button has been pushed, the flow of the subroutine goes on to a step S1707 at which deformation processing is carried out. At the next step S1708, results of the processing are stored.

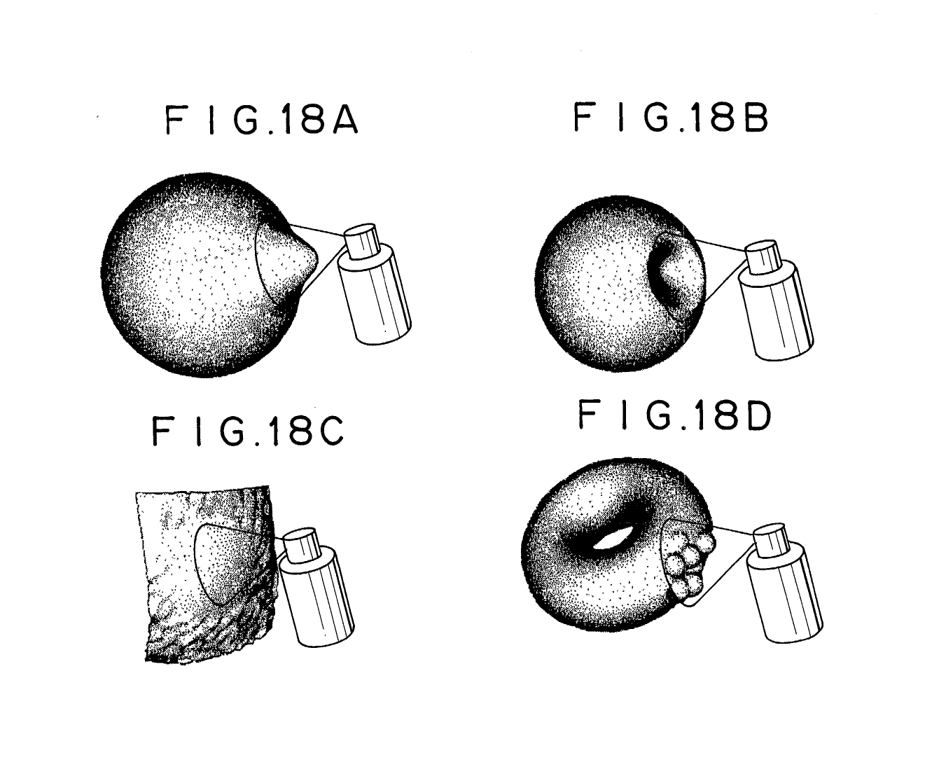

FIGS. 18A through 18D are diagrams showing examples of the deformation processing carried out by using the spray tool at the step S1707. By setting various kinds of processing to be carried out in accordance with the position and the posture of the spray tool, various kinds of deformation can be performed. By adoption of the FFD technique used in the first embodiment, for example, the surface of the 3-dimensional model can be pulled out as shown in FIG. 18A or pushed in as shown in FIG. 18B. In addition, the surface can also be smoothed as shown in FIG. 18C or another 3-dimensional model is placed on the surface as shown in FIG. 18D. In another example, by setting a variety of processing parameters for modifying attributes of a 3-dimensional model, which are associated with a processing tool, various kinds of deformation and paint processing can be carried out.

In the processing to smooth the surface of a 3-dimensional model as shown in FIG. 18C, an operating area and a set of bottom points can be regarded as discrete signals. The set of bottom points compose a deformation area on the surface of the 3-dimensional model. The deformation area is prescribed to exist on the surface of the 3-dimensional model. By carrying out deformation wherein the signals are passed through a low-pass filter, the deformation processing can be implemented. The degree of smoothness can be set in the tool as a parameter. By changing this parameter, the degree of smoothness can be modified from deformation to deformation.

As described above, in deformation processing, another 3-dimensional model is placed on the surface as shown in FIG. 18D. This processing provides an image wherein particles of the other 3-dimensional model are output from the spray tool through the operating area and stuck on the 3-dimensional model being processed. Boolean processing to add polygon models can be taken as an example of concrete processing. Assume that there are A and B polygon models. In processing to add the 2 polygon models, they are combined to produce a synthesis model (A+B) representing the sum of the polygon models A and B. In processing to subtract the polygon model B from the polygon model A, on the other hand, a junk having the shape of the polygon model B is taken out from the polygon model A to produce a difference (A−B). It is possible to provide a configuration wherein this subtraction is used in the deformation processing.

A 3-dimensional model comprising models stacked on each other can have any arbitrary shape. The frequency at which a 3-dimensional model is output by the spray tool, that is, the density of the output 3-dimensional model, can be represented by a parameter. Thus, the density can be changed. In the above description, the spray tool has an operating area with a conical shape shown in FIG. 16 or FIGS. 18A through 18D. It should be noted, however, that the operating area can have any shape. In addition, the spray tool itself can have any shape as well. In addition, the number of operating areas is not limited to 1. That is to say, the spray tool can have a plurality of operating areas.

Third Embodiment

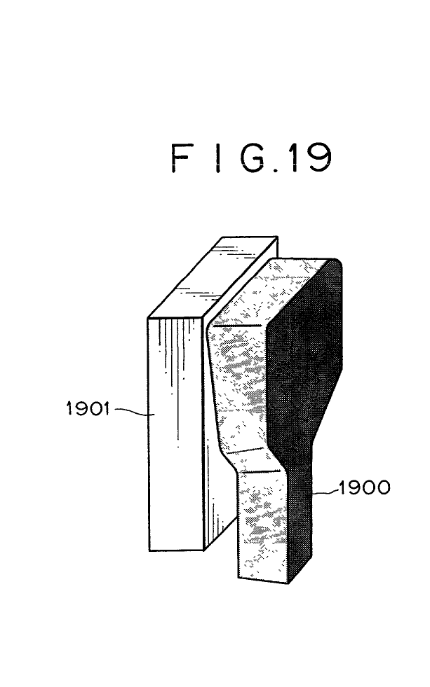

Next, as a third embodiment, processing of a tanning tool for carrying out deformation to smooth the surface of a 3-dimensional model is explained. A tanning tool 1900 is used for carrying out processing to smooth a deformation area which is an area prescribed as an intersection area of a defined rectangular-parallelopiped-operating area 1901 and the surface of a 3-dimensional model as shown in FIG. 19. Unlike the first embodiment, the tanning tool 1900 is not capable of passing through the surface of a 3-dimensional model. After the tanning tool 1900 collides with the surface of a 3-dimensional model, the tanning tool 1900 smoothly crawls over the surface, carrying out processing to smooth a deformation area in accordance with an input entered via a button set on a 3-dimensional sensor assigned to the tanning tool 1900. The deformation area is the surface of the 3-dimensional model overlapping the operating area.

The deformation processing to smooth the surface of a 3-dimensional model by using a tanning tool 1900 is similar to the deformation processing shown in FIG. 18C. That is to say, an operating area and a set of bottom points can be regarded as discrete signals. The set of bottom points compose a deformation area on the surface of the 3-dimensional model. The deformation area is prescribed to exist on the surface of the 3-dimensional model. By carrying out deformation wherein the signals are passed through a low-pass filter, the deformation processing can be implemented. The degree of smoothness can be set in the tool as a parameter. By changing this parameter, the degree of smoothness can be modified from deformation to deformation. For example, the degree of smoothness can be set for each movement of the tanning tool 1900.

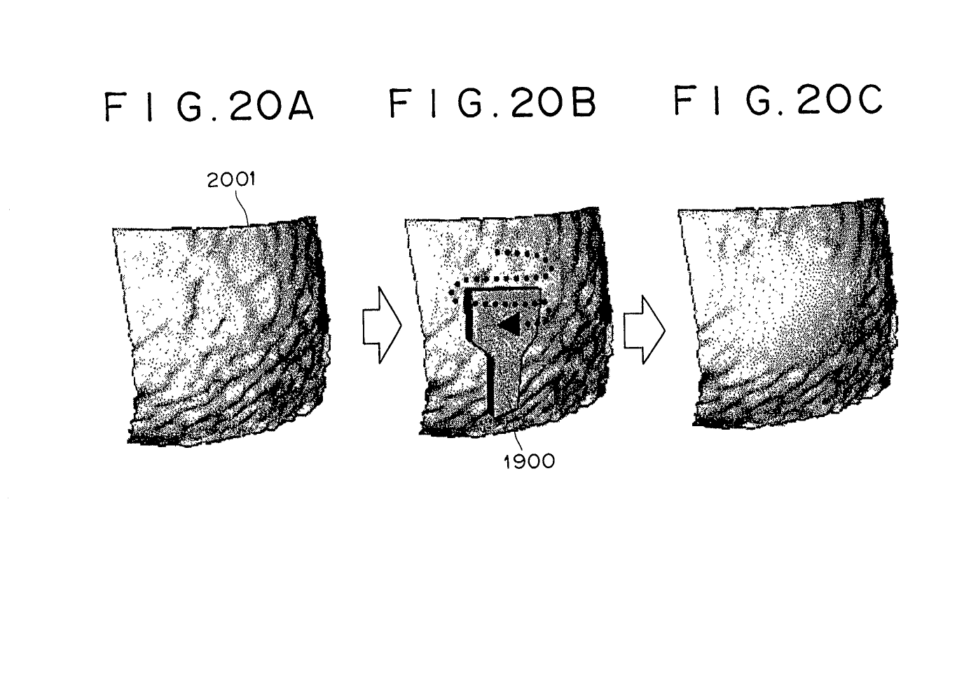

FIGS. 20A through 20C are operation examples to deform a 3-dimensional model by using the tanning tool 1900. Assume a 3-dimensional model with a rough surface 2001 as shown in FIG. 20A. The operator operates a 3-dimensional sensor to stroke and smooth the surface 2001 by using the tanning tool as shown in FIG. 20B. The surface's portion stroked by the tanning tool 1900, that is, the deformation area, is smoothed as shown in FIG. 20C. To put it concretely, a set of bottom points can be regarded as discrete signals. The set of bottom points compose a deformation area on the surface of the 3-dimensional model. By carrying out deformation wherein the signals are passed through a low-pass filter, attribute data of a deformation area prescribed on the surface of the 3-dimensional model can be changed. As a result, a smooth surface is shown on the display unit.

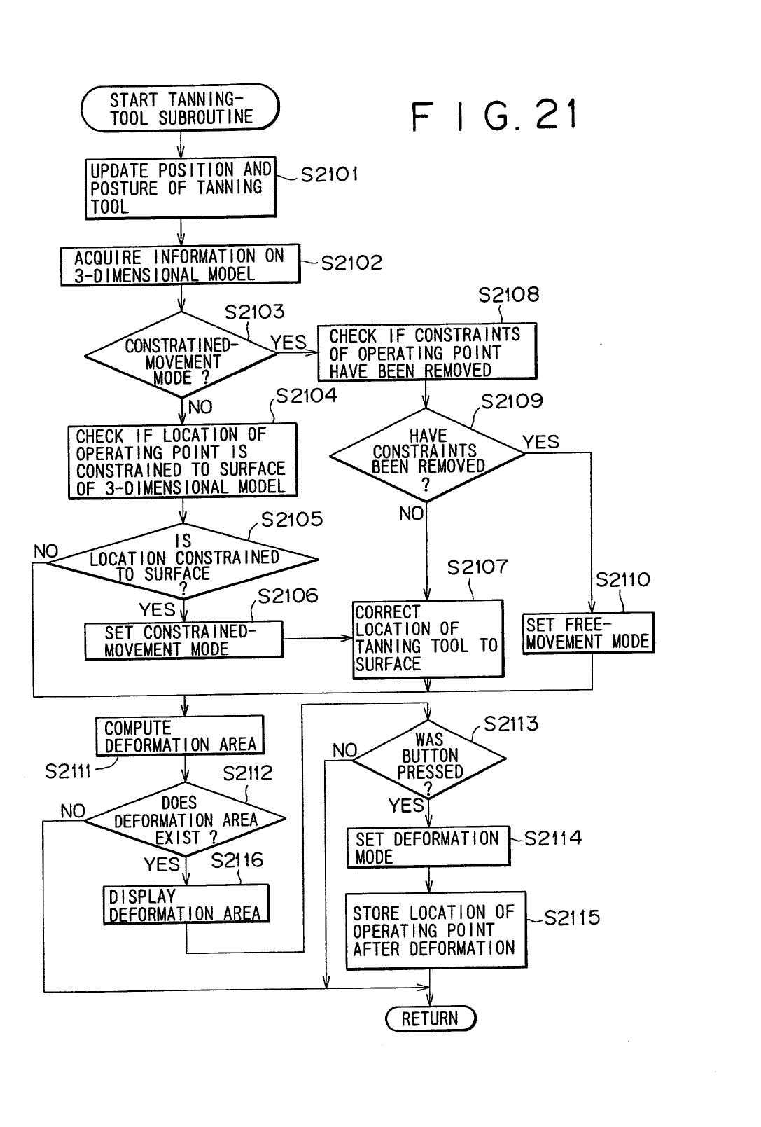

FIG. 21 is a flowchart representing processing of the tanning tool. The tanning tool has a configuration allowing a constrained-movement mode wherein the position of the tool is constrained on the surface of a 3-dimensional model or a free-movement mode wherein the position of the tool is unconstrained. As shown in the figure, the flowchart begins with a step S2101 at which the position and the posture of the tanning tool are updated. At the next step S2102, information on the 3-dimensional model is acquired. Then, the flow of the subroutine goes on to a step S2103 to from a judgment as to whether the mode is a constrained-movement mode or a free-movement mode. If the mode is not a constrained-movement mode, the flow of the subroutine goes on to a step S2104 at which a condition for constraining the tanning tool on the surface of the 3-dimensional model is examined to determine whether the condition is satisfied. The condition can be whether or not the position of the tanning tool has passed through the surface of the 3-dimensional model, whether or not the position of the tanning tool has approached the surface of the 3-dimensional model at a distance shorter than a predetermined value or another condition. The flow of the subroutine then goes on to a step S2105 to form a judgment as to whether or not the tanning tool should be constrained on the surface of the 3-dimensional mode is satisfied. The judgment is based on a result of the examination carried out at the step S2104. If the tanning tool should be constrained on the surface of the 3-dimensional mode, the flow of the processing goes on to a step S2106 at which the constrained-movement mode is established. At the next step S2107, the tanning tool is corrected to a position on the surface of the 3-dimensional model. If the outcome of the judgment formed at the step S2103 indicates that the mode is a constrained-movement mode, on the other hand, the flow of the subroutine goes on to a step S2108 at which a condition for terminating the constrained-movement mode is examined to determine whether the condition is satisfied. That is to say, the condition is examined to form a judgment as to, among others, whether or not the position in a state with no constraints of the operating point has been moved to a location on the front side or whether or not the position of the operating point has been moved to a location on the front side at least at a certain distance from the surface of the 3-dimensional model. The position in a state with no constraints of the operating point is a position at the time the processing of the step S2101 is carried out. As described earlier, the front side is a pre-constraint side with respect to the surface of the 3-dimensional model. The flow of the subroutine then goes on to the next step S2109 to form a judgment as to whether or not to remove the constraints. The formation of the judgment is based on a result of the examination obtained at the step S2108. If the constraints are to be removed, the flow of the subroutine goes on to a step S2110 at which a free-movement mode is established. If the constraints are not to be removed, on the other hand, the flow of the subroutine goes on to the step S2107 at which the tanning tool is corrected to a position on the surface of the 3-dimensional model.

At a step S2111, a deformation area is computed. A deformation area is an overlap of the operating area and the surface of a 3-dimensional model. The flow of the subroutine then goes on to a step S2112 to form a judgment as to whether or not a deformation area exists. If a deformation area exists, the flow of the subroutine goes on to a step S2116 at which the deformation area is displayed. It should be noted that the processing carried out at the step S2116 can be omitted. If the outcome of the judgment formed at the step S2112 indicates that a deformation area does not exist, on the other hand, the routine is ended. After the step S2116, the flow of the subroutine goes on to a step S2113 to form a judgment as to whether or not the button has been pressed. If the button has been pushed, the flow of the subroutine goes on to a step S2114 at which deformation processing is carried out on the basis of information on the deformation area. The deformation processing is carried out to smooth the deformation area as is the case with the second embodiment. At the next step S2115, information on the deformed 3-dimensional model is stored in a data memory.

The operation carried out on a button provided on a 3-dimensional sensor assigned to the tool can be omitted. In such a configuration, an overlap of an operating area and the surface of a 3-dimensional model is always deformed. In the case of such a configuration, the outcome of the judgment formed at the step S2113 to determine whether the button has been pressed is always forced to YES. In addition, an operation carried out on the tool by using a means other than a button or another input means can be used as a condition for starting and ending the processing.

In the embodiment described above, the operating area has a rectangular-parallelopiped shape. It should be noted, however, that the operating area can have any arbitrary shape. In addition, the spray tool itself can have any shape as well. In addition, the number of operating areas is not limited to 1. That is to say, the spray tool can have a plurality of operating areas.

Fourth Embodiment

In the case of a fourth embodiment, a deformation tool having a geometrical shape is operated by using a 3-dimensional sensor provided with a button. In the configuration of this embodiment, a 3-dimensional model is deformed to reflect the geometrical shape of the deformation tool.

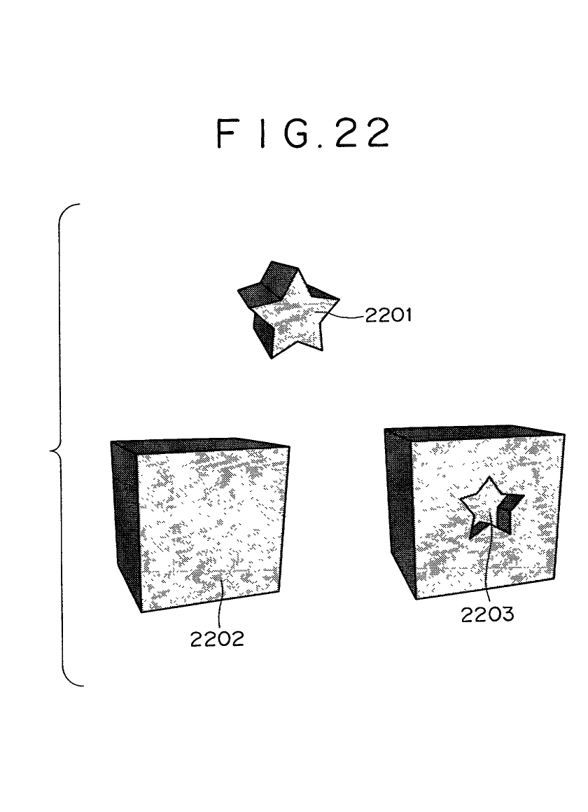

One configuration of the fourth embodiment includes a removal tool 2201 like one shown in FIG. 22. The removal tool 2201 is a tool for removing a portion having the same shape as the removal tool 2201 from a 3-dimensional model 2202. Assume for example that the removal tool 2201 having a star shape is placed at an arbitrary position on the 3-dimensional model 2202 and a button of a 3-dimensional sensor assigned to the removal tool 2201 is pressed. In this case, a portion of the 3-dimensional model 2202 overlapped by the removal tool 2201 is cut out to result in a dent 2203 with a star shape on the surface of the 3-dimensional model 2202. In this processing, an operating area of the removal tool 2201 is set on the star area of the removal tool 2201 itself. An overlap area of the operating area and the area of the 3-dimensional model 2202 is treated as a deformation area. The deformation processing can be implemented by modifying attributes of the deformation area.

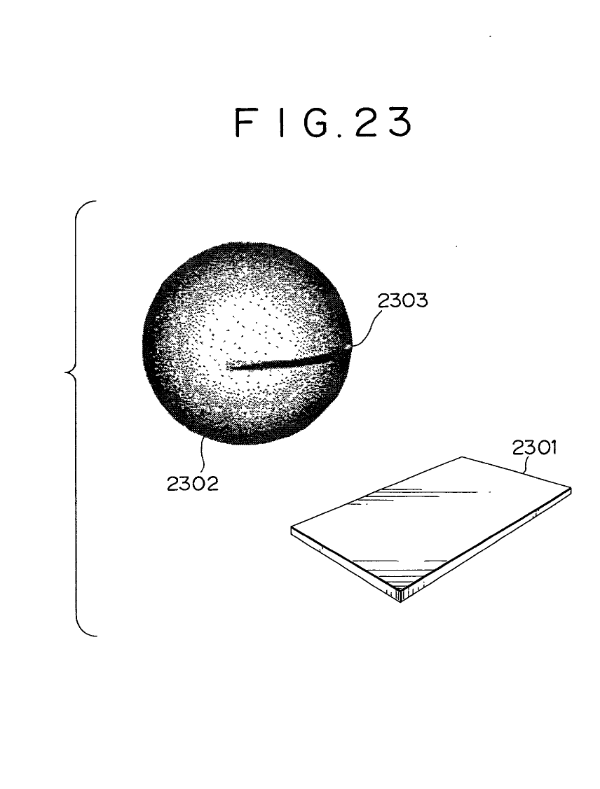

The shape of the removal tool does not have to be a star. The removal tool can have any arbitrary shape as long as Boolean processing can be carried out on the shape. The removal tool can be a planar tool 2301 as shown in FIG. 23. In this case, a cut 2303 can be resulted in on a 3-dimensional model 2302 by using the planar removal tool 2301. In this case, an operating area of the planar removal tool 2301 is set on the shape area of the planar removal tool 2301 itself.

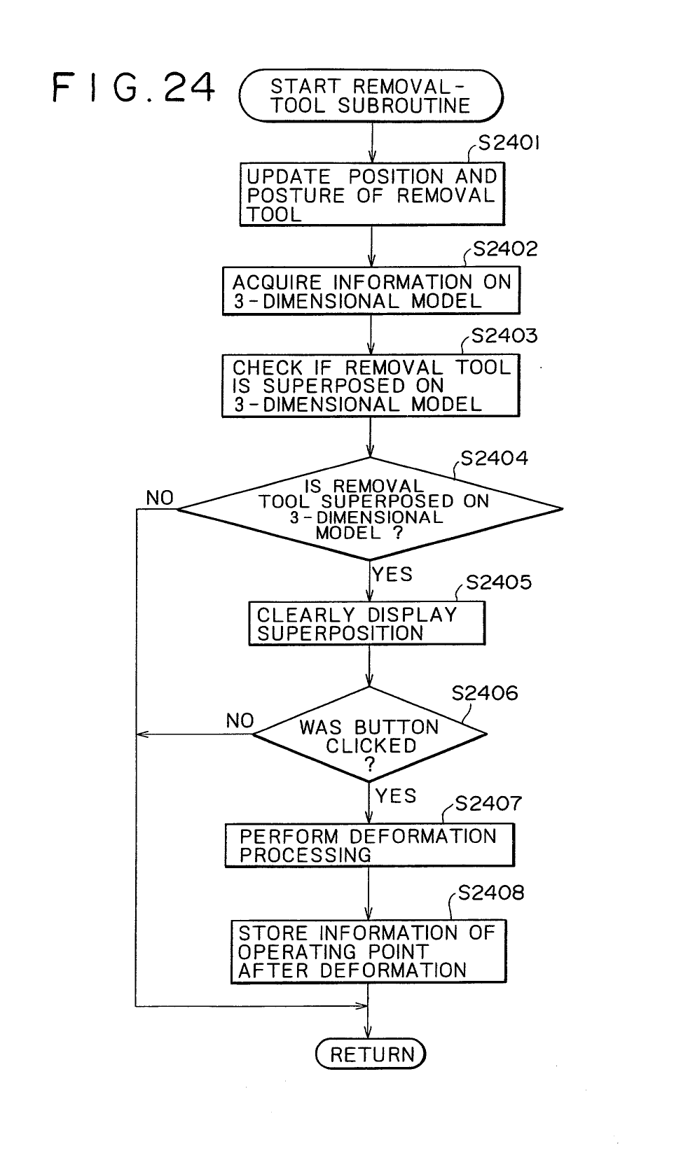

FIG. 24 is a flowchart representing processing of the removal tool. As shown in the figure, the flowchart begins with a step S2401 at which the position and the posture of the removal tool are updated. At the next step S2402, information on the 3-dimensional model is acquired. At the next step S2403, an overlap of the 3-dimensional model and the shape of the removal tool is computed. The flow of the subroutine then goes on to a step S2404 to form a judgment as to whether or not an overlap exists. If an overlap exists, the flow of the subroutine goes on to a step S2405 at which the overlap is clearly displayed. As a conceivable method of clearly displaying an overlap, the 3-dimensional model or the removal tool is made half transparent. The processing carried out at the step S2405 to clearly display the overlap can be omitted. If an overlap does not exist, on the other hand, the routine is terminated. The flow of the subroutine then goes on to a step S2406 to form a judgment as to whether or not the button has been clicked. If the button has been clicked, the flow of the subroutine goes on to a step S2407 at which actual deformation processing is carried out. At the next step S2408, results of the deformation processing are stored. If the button has not been clicked, on the other hand, the routine is terminated. Typical deformation processing is implemented by changing attribute data of the 3-dimensional model through subtraction A−B where notation A denotes polygon data of the 3-dimensional model and notation B denotes polygon data of the removal tool.

At the step S2406, instead of forming the judgment as to whether or not the button has been clicked, it is possible to form judgment as to whether or not the button has been pressed. If the latter judgment is formed, the 3-dimensional model's portion having the same shape as the removal tool is cut out continuously while the button is being pressed. As a possible alternative, the operation carried out on a button provided on a 3-dimensional sensor assigned to the tool can be omitted. In this configuration, an overlap of the removal tool and the surface of a 3-dimensional model is always cut out. In the case of such a configuration, the outcome of the judgment formed at the step S2406 to determine whether the button has been clicked is always forced to YES.

In addition, addition can also be applied to the deformation processing carried out at the step S2407 to implement a configuration wherein a copy of the removal tool is joined with the 3-dimensional model. In a configuration wherein the removal tool has a function to select addition or subtraction to be applied to the current deformation processing, various kinds of deformation can be carried out by properly setting the function of the tool

In the 3-dimensional-model-processing apparatus shown in FIG. 1 described above, each 3-dimensional-model-processing program and the deformation-processing program are stored in the program memory. It is worth noting that a processing program can also be stored in another storage medium such as a CD-ROM, an optical disc like a DVD-ROM, a CD-R, a CD-RW or a DVD-RAM, a magneto-optical (MO) disc, a magnetic disc like a hard disc or a floppy disc, a semiconductor memory like a memory stick, or tape media like a DAT or 8-mm tape. In the case of either storage medium used for storing a processing program prescribing any of the methods described before, there is provided a configuration wherein the processing program is loaded into a RAM from the storage medium for execution by a computer.

In the configurations described above, by defining an operating point or an operating area, an operation to deform a 3-dimensional model appearing on the display unit can be carried out with ease. The configurations provided by the present invention are effective interfaces for little children or very old people, who have difficulty in handling a computer's contemporary popular input devices such as a keyboard and a mouse or a controller of a computer game. In addition, applications to information education tools using digital technologies can be expected.

In the embodiments described above, implementations of processing are explained by focusing on some deformation processes. It should be noted, however, that also in paint processing such as changing colors of the surface of a 3-dimensional model or writing characters on the surface, an operating point or an operating area is defined and clearly shown on a display unit. As a result, the processing can be carried out with ease and with a high degree of accuracy.

The processing provided by the present invention can be applied not only to deformation of a 3-dimensional model, but also to various kinds of processing such as painting and modification of a color of a 3-dimensional model. As a matter of fact, the scope of the present invention is limited only by claims appended to this specification.

Although the present invention has been described with reference to specific embodiments, those of skill in the art will recognize that changes may be made thereto without departing from the spirit and scope of the invention as set forth in the hereafter appended claims.

We claim as our invention:

1. A 3-dimensional-model-processing apparatus for processing a 3-dimensional model appearing on a display unit on the basis of 3-dimensional-position information input from a 3-dimensional sensor, said 3-dimensional-model-processing apparatus comprising:
a controller for setting an operating point or an operating area used as a position at which processing using a processing tool is to be carried out on said 3-dimensional model serving as a processed object appearing on said display unit as a position dependent upon the position of said processing tool and carrying out said processing on said 3-dimensional model at said set operating point or said set operating area.

2. A 3-dimensional-model-processing apparatus according to claim 1, wherein said controller sets an overlap portion of said operating point or said operating area and said 3-dimensional model as a processing execution position.

3. A 3-dimensional-model-processing apparatus according to claim 1, wherein said controller executes control to clearly display said operating point or said operating area on said display unit.

4. A 3-dimensional-model-processing apparatus according to claim 1, wherein:
said operating point or said operating area is allowed to be updated as a position dependent upon said processing tool by changing and/or re-setting said operating point or said operating area; and
said controller carries out, if said operating point or said operating area is updated, said processing on said 3-dimensional model at said updated operating point or said updated operating area.

5. A 3-dimensional-model-processing apparatus according to claim 1, wherein said controller executes control to make said operating point movable, constraining said operating point on positions on said surface of said 3-dimensional model being processed.

6. A 3-dimensional-model-processing apparatus according to claim 1, wherein:
said operating area is set as an area having a shape matching the shape of said processing tool; and
said controller carries out processing according to the shape of said operating area set as an area having a shape matching the shape of said processing tool on said 3-dimensional model.

7. A 3-dimensional-model-processing apparatus according to claim 1, wherein said controller carries out processing on said 3-dimensional model on the condition that an overlap portion of said operating point or said operating area and said 3-dimensional model has been detected.

8. A 3-dimensional-model-processing apparatus according to claim 1, wherein said controller carries out processing on said 3-dimensional model on the condition that an overlap portion of said operating point or said operating area and said 3-dimensional model has been detected and that a processing command has been received from input means.

9. A 3-dimensional-model-processing method for processing a 3-dimensional model appearing on a display unit on the basis of 3-dimensional-position information input from a 3-dimensional sensor, comprising the steps of:
setting an operating point or an operating area used as a position at which processing using a processing tool is to be carried out on said 3-dimensional model serving as a processed object appearing on a display unit as a position dependent upon said position of said processing tool; and
carrying out said processing on said 3-dimensional model at said set operating point or said set operating area.

10. A 3-dimensional-model-processing method according to claim 9, further comprising the step of setting an overlap portion of said operating point or said operating area and said 3-dimensional model as a processing execution position.

11. A 3-dimensional-model-processing method according to claim 9, further comprising the step of displaying said operating point or said operating area on said display unit.

12. A 3-dimensional-model-processing method according to claim 9, wherein:
said operating point or said operating area is allowed to be updated as a position dependent upon said processing tool by changing and/or re-setting said operating point or said operating area; and
if said operating point or said operating area is updated, said processing on said 3-dimensional model is carried out at said updated operating point or said updated operating area.

13. A 3-dimensional-model-processing method according to claim 9, further comprising the step of executing control to make said operating point movable, constraining said operating point on positions on said surface of said 3-dimensional model being processed.

14. A 3-dimensional-model-processing method according to claim 9, further comprising the steps of:
setting said operating area as an area having a shape matching the shape of said processing tool; and
carrying out processing according to the shape of said operating area set as an area having a shape matching the shape of said processing tool on said 3-dimensional model.

15. A 3-dimensional-model-processing method according to claim 9, further comprising the step of carrying out processing on said 3-dimensional model on the condition that an overlap portion of said operating point or said operating area and said 3-dimensional model has been detected.

16. A 3-dimensional-model-processing method according to claim 9, further comprising the step of carrying out processing on said 3-dimensional model on the condition that an overlap portion of said operating point or said operating area and said 3-dimensional model has been detected and that a processing command has been received from input means.

17. A program-providing medium comprising:
a computer program to be executed on a computer system for processing a 3-dimensional model appearing on a display unit on the basis of 3-dimensional positional information input from a 3-dimensional sensor, the computer program comprising the steps of:
setting an operating point or an operating area used as a position at which processing using a processing tool is to be carried out on said 3-dimensional model serving as a processed object appearing on a display unit as a position dependent upon said position of said processing tool; and
carrying out said processing on said 3-dimensional model at said set operating point or said set operating area.
